(19) United States
(12) Patent Application Publication
(10) Pub. No.: US 2015/0242979 A1
(43) Pub. Date: Aug. 27, 2015

(54) Knowledge Management and Classification in a Quality Management System

(71) Applicant: University of Maryland, College Park, College Park, MD (US)

(72) Inventor: Leigh Roy ABTS, Phoenix, MD (US)

(21) Appl. No.: 14/245,631

(22) Filed: Apr. 4, 2014

Related U.S. Application Data
(63) Continuation-in-part of application No. 14/190,073, filed on Feb. 25, 2014.

(51) Int. Cl. G06Q 50/20; G06Q 10/10

(52) U.S. Cl. CPC G06Q 50/2057; G06Q 10/103

(57) ABSTRACT

A system manages education, career planning, workforce mobility for students and workers includes a database configured to store a code corresponding to a classification of a course. The course can include a single learning unit or any combination of learning units. The database also stores learner information including at least one code corresponding to the classified course and one code corresponding to assessment information for the classified course. An interface is configured to suggest recommended courses based on the learner information.

### PRIORITY

This application claims priority to U.S. Provisional Patent application U.S. patent application Ser. No. 14/190,073 filed Feb. 25, 2014, which claims priority to U.S. Provisional Application No. 61/769,309 filed Feb. 26, 2013, the contents of each of which is hereby incorporated herein in its entirety.

This invention was made with government support under DRL1118755 and EEC1009823 awarded by the National Science Foundation. The government has certain rights in the invention.

### FIELD

One embodiment is directed to a learning management system. More particularly, one embodiment is directed to a system of classifying and managing structured learning units.

### BACKGROUND INFORMATION

A typical learning environment may separate coursework by subject and group topics within each subject together in a logical way. For example, a subject called “Algebra I” may introduce algebraic concepts and provide for instruction and evaluation of students taking the class. “Algebra II” may cover the same topics as foundational knowledge but provide more difficult problems and more intricate problems to build and develop new concepts for students to master in the field of algebraic mathematics. The class may present word problems for the student to solve by determining the physical relationships among fact elements and some unknown elements. Such word problems may represent a real world scenario from which to extract facts, but are word problems, not experiential problems.

The topics covered in an Algebra class may involve math concepts such as functions, linear equations, polynomials, and graphic concepts involving slopes and curves. In order to teach students a subject in the traditional course/topic model in this example, instructors will typically provide students with the mathematic instruction covering the topic and discuss practice problems with the students. The students will typically then continue to practice the concepts through homework that may be evaluated for progress. Eventually the student will be evaluated for knowledge by broad based testing for each lesson, sequences of lessons, chapter, semester of material, and cumulatively, through state-wide achievement tests, or such tests as the “SAT,” “ACT,” and Advanced Placement (“AP”) tests. At the end of the course or unit, the student will have either passed or failed the course or unit and will typically receive some sort of percentage grade that is supposed to reflect the students' mastery over the course or unit material.

One issue with the traditional learning model is that it does little to provide students with actual real world skills and to track those skills. Because the emphasis is on learning course content, students generally do not demonstrate the ability to apply the course content in a non-academic or cross-disciplined setting or from activities associated with informal learning, such as an after-school project, work-study, internship, or competition. Indeed, often no heed is given at all to applying the underlying processes to demonstrate through a project based, experiential exercise. Another issue with the traditional learning model is that the course grade does not offer any indication of the mastery of the students with respect to real world, practical applications that can be found in the workplace. Yet another issue with the traditional learning model is that it is not easily adapted to provide students with aptitude in a particular area to steer particularized learning experience based on needed skills so that some students, perhaps with different learning styles and abilities or who have demonstrated in a classroom versus an online versus a home school environment, may unnecessarily repeat coursework in which proficiency has already been attained.

Another issue with the traditional learning model is that there is not always alignment between topics targeted and those actually covered in a course. Indeed, even though some learning models have recently evolved to focus on “common core” topics, there will inevitably be course topics that are covered outside of the “common core” or topics in the “common core” that are not covered in a particular course or have been covered in an informal learning environment, such as a competition or through a commercial enterprise such as “Sylvan Learning” or through an online course. Thus, disconnection can exist between two of the same classes in two different environments with no ability to capture the differences. As a student moves from one class to the next, or online course to online course, or from one informal learning opportunity to the next, discrepancies in pre-requisite knowledge and skills can be exacerbated detrimentally to the student. Another issue with the traditional learning model is that there is no support for asynchronous and/or flipped modalities that can cross learning environments, where students can be guided or learn online, or after class or even self-learn at home and come to class to work problems. Flipped and asynchronous learning environments lack uniformity of teaching and evaluation standards. Another issue with the traditional learning model is that students do not benefit from having peer mentors or mentors other than their teachers or instructors. Another issue is that traditional learning models lack the ability to ingest and track student learning from multiple sources, external or internal to traditional or modern learning environments.

### SUMMARY

One embodiment is a system that manages education, career planning, and workforce mobility for students and workers. The system includes a database configured to store a code corresponding to a classification of a course. The course can include a single learning unit or any combination of learning units. The database also stores learner information including at least one code corresponding to the classified course and one code corresponding to assessment information for the classified course. An interface is configured to suggest recommended courses based on the learner information.

Another embodiment is a system that credits a course. A database stores information for a course. The information includes a plurality of code segments, where each code segment represents a learning segment of the course. The course has one or more learning units. A course crediting module receives codes segment information from a learner corresponding to a missing code segment for the course. A course award module analyzes completed code segments and awards a code to the learner when a criteria for code segments required by the course is complete.

Another embodiment is a system of managing learning. A case management module tracks a learner's personal attributes, learning, and career progress. A prediction module analyzes the learner's progress, personal attributes, and assessment information to predict the performance of the learner in a course. A course recommendation module analyzes the learner's progress and recommends courses based on the learner's progress, the learner's personal attributes, and the learner's predicted performance.

Another embodiment is a system of classifying a course. A course classification module classifies a course based on learning environment and subject criteria. A course segment classification module classifies segments of a course based on targeted skills and assessment criteria. A coding module assigns a code for each course segment and assigns a code for the course. A coding assessment module assigns codes corresponding to assessment criteria for each course segment and assigns codes corresponding to assessment criteria for the course.

Another embodiment is a system of rating an individual. A code analyzing module analyzes codes earned by the individual. A rating module rates the individual based on the codes earned.

Another embodiment is a method of applying code profiles to individuals. An individual is evaluated based on the individual's performance in an activity. An activity code is applied to the individual where the code represents completion of the activity. A proficiency code is applied to the individual where the code represents a proficiency level associated with the activity. The activity and proficiency codes combine with other achieved codes to provide a coded description of the individual's activities.

### BRIEF DESCRIPTION OF THE DRAWINGS

FIG. 1 is a block diagram of a computer server/system, in accordance with an embodiment of the present invention.

FIG. 2 shows an illustration of a QMS demonstrating chains of reasoning between PSLEDs, skills, disciplines, and certificates, in accordance with some embodiments.

FIG. 3 illustrates a system diagram for a QMS in accordance with some embodiments.

FIG. 4 is a flow diagram illustrating courses that are classified and coded, codes that are assigned to students, and courses that are recommended to students, in accordance with some embodiments.

FIG. 5 is a flow diagram that illustrates how example educational models can be used to classify PSLEDs, clusters, courses, and course segments or units, in accordance with some embodiments.

FIG. 6 is a logic diagram illustrating the relationship of the QMS with example educational models, in accordance with some embodiments.

### DETAILED DESCRIPTION

Recent studies on students (or any type of learner) and learning systems have argued that learning should focus on combinations of skills, knowledge, and abilities (“KSAs”). In particular, researchers argue that students need to gain and practice “21st century skills” and that the workforce needs to develop and maintain “21st century skills.” These so-called 21st century KSAs can involve skills that include learning and innovation skills, 21st century themes, life and career skills, and the like. Example learning and innovation skills can involve skills including critical thinking and problem solving, creativity and innovation, communication and collaboration, scientific and numerical literacy, cross-disciplinary thinking, basic literacy, and the like. Example 21st century themes can involve issues surrounding global awareness; financial, economic, business, and entrepreneurial literacy; civic literacy; health literacy; environmental literacy, and the like. Example life and career skills can include flexibility and adaptability, initiative and self-direction, social and cross-cultural skills, productivity and accountability; leadership and responsibility, and the like.

Known learning frameworks and standards recognize the concept of aligning a range of KSAs to particular subject areas. For example “Common Core,” “Common Core Standards of Mathematics Practice,” and “Next Generation Science Standards” all include consideration for aligning subject material with KSAs. Government is also involved in the discussion of aligning KSAs to learning platforms. For example, the U.S. Department of Education set forth the expectations of the educational system (federal, state, districts and schools) by outlining benchmarks to prepare and assess students to be college and career ready.

The cost of education is ever increasing and it may be that the Pareto principle holds in education as it does in other areas. For example, in healthcare, approximately 20% of patients incur 80% of the cost of healthcare. In education, it may be that 20% of students incur 80% of the overall cost of education. Different populations and localities may have different percentages. In addition, the standard for measuring the “cost” of education may vary based on the needs of the demographics. For example, in an inner city school, a higher percentage of students may be at risk due to their environmental setting. Thus, one can risk-adjust this relationship. Most students may require little intervention, but some students may require greater hands-on time with teachers, disciplinary issues that drain resources, and alternative learning environments to facilitate more efficient learning. By classifying courses and accounting for the unconventionalities and peculiarities of individual students, the cost of education can be lessened significantly by improving the learning experience and learning outcomes of a relatively small number of students through development of individualized classification schema that rank student education and professional development risk, learning plans, and case management-like guidance.

No clear and consistent system exists, however, that addresses the issues involved with managing course content and students in learning systems that focus on 21st century skills, or in fact, for general education and professional development. U.S. patent application Ser. No. 14/190,073 by the instant inventor, the contents of which has been hereby incorporated herein in its entirety, describes a system of aligning 21st century skills to course content. The present application discloses particular aspects of a system that can be used to manage learning systems and students. This application presents a methodology to guide and assess students and grouping of students to assist them to obtain their desired education, and career pathway outcomes through the development of individualized Education Plans, Career Plans, and Case Management based on data. In addition, the present application discloses alternative embodiments and uses that go beyond learning system and demonstrate the use of the system discloses to manage other aspects of knowledge, skill, and experience tracking.

There are no known systems to manage and track knowledge, skills, abilities, and experience of students, professionals, teachers, practitioners, and others related to the broad range of 21st century KSAs in the range of procedural, cognitive, behavioral, and attitudinal constructs that demonstrate college, career, and workforce readiness and expertise. As discussed below, classification and codification of skills based learning experiences provides a hook to provide end-to-end management and service of those using classified learning elements, the codes associated with the learning elements, and the classification of the learning elements themselves.

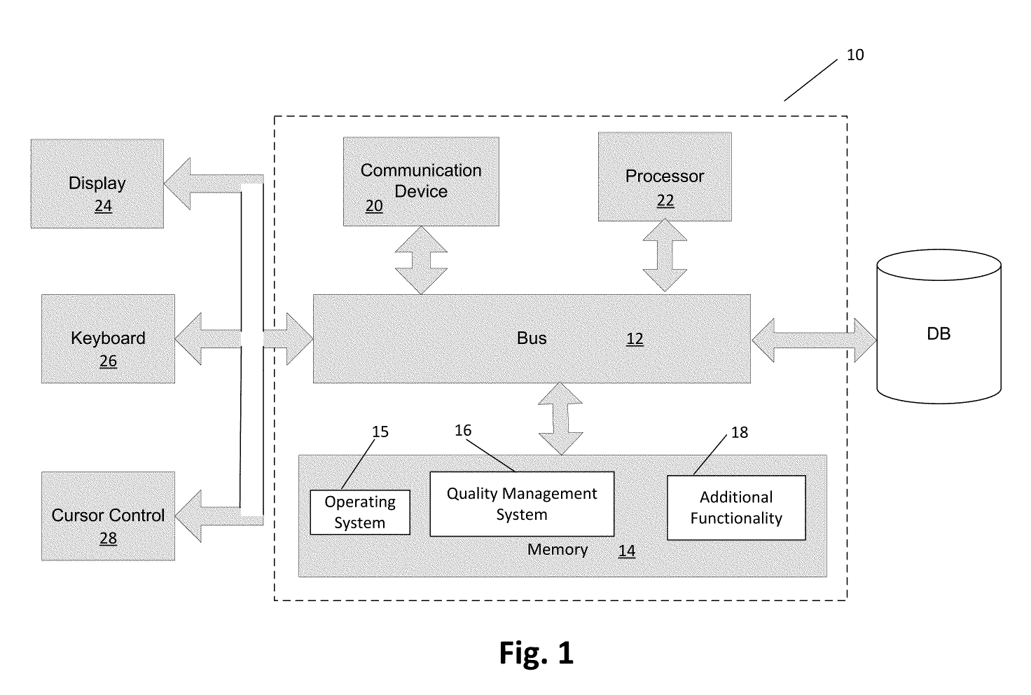

FIG. 1 is a block diagram of a computer server/system 10 in accordance with an embodiment of the present invention. Although shown as a single system, the functionality of system 10 can be implemented as a distributed system. System 10 includes a bus 12 or other communication mechanism for communicating information, and a processor 22 coupled to bus 12 for processing information. Processor 22 may be any type of general or specific purpose processor. System 10 further includes a memory 14 coupled to bus 12 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, coupled to bus 12 to provide access to a network (not shown). Therefore, a user may interface with system 10 directly, or remotely through a network or any other known method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10. Other known (such as touch devices) or yet to be developed interfaces may also readily be interchanged with keyboard 26 and cursor control device 28.

In one embodiment, memory 14 stores software modules that provide functionality when executed by processor 22. The modules include an operating system 15 that provides operating system functionality for system 10. The modules further include a quality management system (“QMS”) 16 that provides and processes learning system data, as disclosed in more detail below. System 10 can be part of a larger system, such as a multitude of QMS systems, a learning management system, case management system, personal learning assistance systems, personal tutor, online adaptive learning system, or a learning tracking system. Therefore, system 10 will typically include one or more additional functional modules 18 to include the additional functionality. A database 17 is coupled to bus 12 to provide centralized storage for modules 16 and 18 and store one or more data sets to support contextual data processing, etc. Some embodiments may not include all of the elements in FIG. 1.

A QMS, such as QMS 16, provides an integration and measurement system for tying specific educational content, experiential activities, courses, courses of study, grade level achievements, psychometric surveys, standardized tests, stackable badges (such as certificates and credentials), and individuals' learning and assessment to workforce and academic KSAs, certifications (such as HVAC, “Microsoft” engineer, and “Cisco” engineer certifications), and credentials of all kinds. QMS 16 is a system that is flexible but powerful for providing an avenue of organizing and aligning educational content—through such tools as individualized educational learning and career plans.

QMS 16 can divide educational content and experiences, and work based experiences into problem-solving learning environments and design blocks (“PSLEDs” or “PSLED blocks”). Each PSLED block can represent a unit of student curriculum or instruction, a 21st century based skills, or an assessment track, in addition to any other educational minutia. PSLEDs provide the logical base from which a QMS can create the chains of reasoning and auditable links between a student and teacher or employee and instructor. The terms PSLEDs or PSLED blocks are used interchangeably throughout. Because PSLEDs can be developed using any model, as described in further detail below, one of ordinary skill in the art should understand that where the system is described as working with PSLEDs or PSLED blocks, the system can equally apply to the management of any appropriate learning unit.

PSLED blocks or other learning units can be classified using the techniques described below to categorize particular aspects of the PSLED. PSLEDs can be classified using a variety of criteria. These classifications can be analyzed to determine relational constructs between PSLEDs. For example, PSLEDs can be examined for prerequisites or relatedness. Some more advanced PSLEDs may require completion of prior, or prerequisite, PSLEDs prior to attempting the more advanced PSLEDs. However, through classification, the prior PSLEDs required may result in a number of alternatives that would all suffice to fulfill the requirement. Similarly, PSLEDs can be identified as related or equivalent so that satisfaction of one PSLED can easily be determined to satisfy a prerequisite for another PSLED or a prerequisite to earn a credential or certification based on PSLEDs completed. Further, by classification, PSLEDs can be identified that are desirable to acquire together. For example, one PSLED related to algebraic physics can be identified as being desirable to take with a PSLED related to multivariable polynomials. The content from each PSLED can be identified as cross-supporting of one another. Further, by classification, PSLEDs can be identified that have no overlap in content, which may be desirable to provide delineation in subject matter into separate courses (or lesson plans or units of study). One outcome of classification is that QMS 16 can systematically determine PSLEDs that can be combined to create courses or training programs as well as determine when training from other places, such as apprenticeships, homeschools, or flipped learning environments, can be used to satisfy prerequisites in creating a custom learning plan and custom career plans for an individual or group.

PSLED blocks can be assembled into specific lesson plans, experiential activities, course units, courses, course equivalents, professional development and worker training curricula, and apprenticeships. PSLEDs and clusters of PSLEDs can become the foundation for processes that map ‘equivalency’ of learning and assessment to job related experiences and academic credit across: 1) courses in different disciplines; 2) learning communities; 2) modalities of instruction; 3) certification and credentialing programs; 4) modalities of training and professional development; 5) modalities of distribution, e.g., online, textbooks, media; and 6) development platforms. Classification of PSLEDs can account for all of these considerations.

For example, a student can be assessed to have the knowledge, prior training experience, and critical thinking skills associated with a desired KSA. The assessment can come through other PSLED based processes in the QMS, such as a class that was previously completed, through another QMS operated by another entity, or through some other external source or experience. The student can receive a code for having completed a PSLED or clusters of PSLEDs relating to the particular KSA. The code can also include information regarding the level of proficiency or breadth in the PSLED. The student can take that code and others and use it as a form of currency.

The code is something tangible that the student can use to demonstrate aptitude, self-efficacy through demonstrated tasks and/or achievement of learning goals, or other accomplishments (e.g., such as participation on a team) in a PSLED related to that code. The code can be used to track how the PSLED was modified or adapted for a particular learning environment or type of learning, such as code segments associated with Evidence Centered Design (“ECD”), Understanding by Design (“UbD”), and Universal Design by Learning (“UDL”). The code can also be used to reverse track PSLEDs completed or earned, and through PSLED classification, identify other PSLEDs that are equivalent or are slightly modified based on the learner or on the learning setting by a change in a segment of the code. The codes can thus be used to identify PSLEDs and apply them to satisfy requirements of another class, demonstrate a prerequisite, or achieve a certificate or credential. The codes can be used to track the KSAs needed for a particular career or workforce job. The codes can be used to demonstrate KSAs achieved for particular workforce requirements, and can be used to identify KSAs that need to be ‘earned’ and demonstrated for ‘upward mobility’ within a job, or to move from one job to another.

In some embodiments, codes can be used to screen students or groups of students for learning and practice ‘gaps.’ Such gap analysis can be used to create new and/or modified learning plans for each student aligned to educational, career and workforce aspirations. Codes can be ‘risk analyzed’ which can assist in targeting interventions for particular students by, in a sense, risk adjusting the intervention to assist the student to overcome a deficiency. The codes can have segments related to various aspects of student learning such as assessments conducted and scores related to the assessments. The codes can include keys or segments to psychometric tests that have been conducted and which KSAs were emphasized, such as problem-solving, team work, and collaboration.

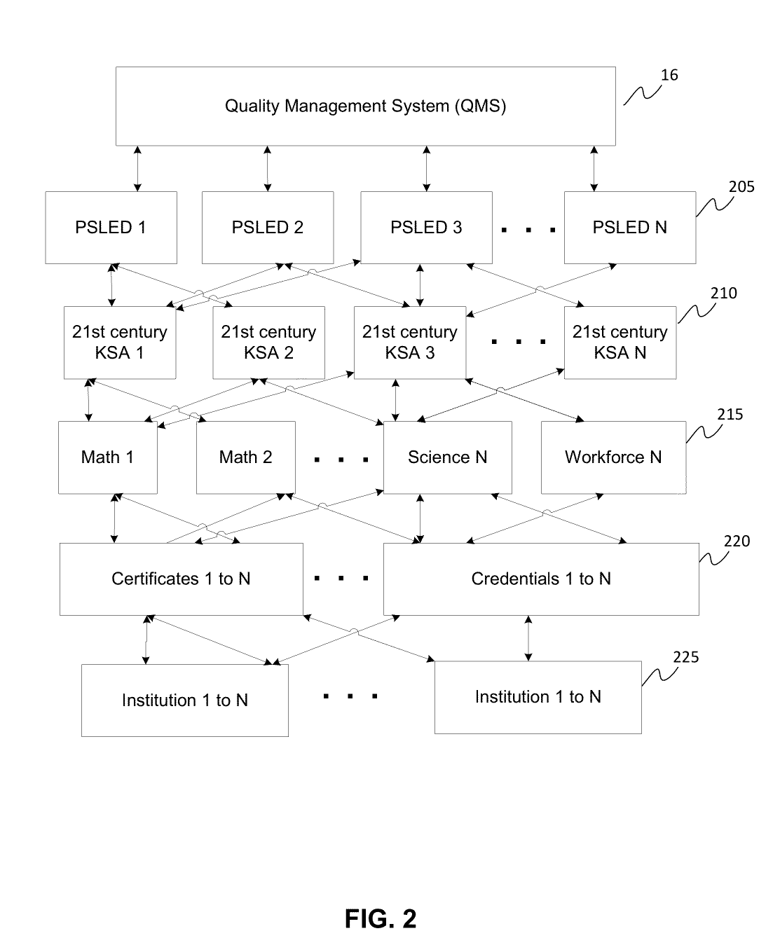

FIG. 2 shows an illustration of a QMS demonstrating a chain of reasoning between PSLEDs, skills, disciplines, and certificates, in accordance with some embodiments. QMS 16 controls and organizes each of a PSLED 1, a PSLED 2, a PSLED 3, and up to a PSLED N, at row 205. Each of the PSLEDs in row 205 is linked to one or more KSAs, at row 210. Each of the KSAs in row 210 is linked to one or more disciplines, subjects, or workforce topics, at row 215. Each of the disciplines, subjects, or workforce topics in row 215 is linked to one or more certificates or credentials, at row 220. Each of the one or more certificates or credentials in row 220 is linked to one or more institutions or employers, at row 225. The links between each row in FIG. 2 are bi-directional so that QMS 16 can be used to develop, maintain, audit, and analyze PSLEDs by following the links from one row to another, either up or down.

Classification of PSLEDs can be developed or understood by referring to FIG. 1 as well. For example, for PSLED 1 in row 205, classification can include that it relates to 21st century KSAs 1 and 2 from row 210, and Math 1, Math 2, and Science N, from row 215. In addition, classification can also consider particular topics within courses, certificates that relate to a PSLED that is being classified, and “cousin” PSLEDs that share some relation through skills targeted or subject matter involved.

The courses in a field or discipline with embedded learning goals for students to develop and practice KSAs can be through PSLEDs developed and organized from the QMS system. PSLEDS can be aligned to specific or multiple KSAs. As the chains of reasoning and auditability form between the PSLEDS and their mappings to KSAs, classifications for PSLEDs will overlay onto various courses and workforce training programs. As such, these classifications can lead to PSLEDS that become the prerequisites for other PSLEDs. Individuals will be able to gain certificates that demonstrate their proficiencies and competencies in a PSLED or clusters of PSLEDs. Individuals can include anyone receiving instruction, including students, teachers, instructors, workers, employees, and the like.

A QMS such as QMS 16 has potential to be applied across, but not limited to:
k-12 and the alignment of curriculum, instruction and assessment to the Common Core (“CC”) and Next Generation Science Standards (“NGSS”);
grades 9-20 career and workforce training pathways including military training programs, and equivalency of these programs to academic or occupational training;
practitioner and professional development training programs and continued professional certifications for fields dependent upon critical KSAs and, in particular, 21st century skills, e.g. problem-solving or teamwork;
programs that prepare teachers, instructors and trainers of students, veterans, and trainees in KSAs—e.g. career apprenticeship programs;
programs that certify and credential developers of PSLEDs;
GED and other equivalency programs;
professional development models for teachers or instructors and for a train the trainer model;
formative and summative assessments across the various PSLED blocks, thus enabling the longitudinal tracking of individual students and cohorts of students;
tracking of student's achievements of classified PSLEDs through code assignment;
codes can be used to create a ‘language’ to organize not only communication, management, and sharing of educational and workforce training information, but also to enable the creation of new models and algorithms that can impact a broad range of educational and workforce training enterprise activities, including development and management of the programs, and re-imbursement structures for those programs;
databases of student achievements across many different sources of educational content;
alignment and scaffolding of rubrics across lesson plans, units, courses, courses of study, badges, certificates, and credentials;
development of individualized learning and career plans;
programs that mine individual achievement, identify areas for growth based on job maintenance, job advancement, or personal interests, and suggest courses, units, or PSLEDs to the individual; and
programs that suggest courses, units, or PSLEDs by aligning personality models to find courses, units, or PSLEDs suited to individuals.

A PSLED block can be any element of curriculum, instruction, assessment, workforce training, experiential learning environment, design project, professional development, and the like. A PSLED block used by the QMS 16 differs from traditional educational concepts in the way that it is developed (and in the way that it is maintained, discussed in further detail below). PSLED blocks can be combined into clusters that represent progressively more inclusive concepts. A cluster of PSLED blocks, for example, can make up the material covered on a particular class day. A cluster of clusters of PSLED blocks can make up the material covered in a syllabus for a particular topic, and a cluster of clusters of clusters of PSLED blocks can make up material covered for a block of topics, such as subjects across a course, subjects across courses, or material across a training program, such as an apprenticeship, and across life experiences such as organized and presented through an e-portfolio, e.g., American Council on Education (“ACE”) credits based on military work experiences and job classifications. PSLEDs and clusters of PSLEDs can be classified and coded. A PSLED can be used to align and link data across systems, including those of other learning management systems, such as “Student Success Matrix” and “Common Data Definitions” available under licensure from Creative Commons.

PSLEDs can be analogized to a set of interlocking toy bricks, such as “Legos.” For example, the set of bricks can include red, blue, and yellow bricks, each color corresponding respectively to curriculum, instruction, assessment PSLEDs. A particular KSA can be built by taking PSLED bricks of different colors and building a shape of different colors that represents a skill in the context of a particular subject, and student learning styles, such as for a blind or deaf person. Different shapes can be combined to demonstrate a skill in a cross-discipline, such a shape for math and a shape for biology. Other colored bricks, such as an orange brick can include PSLEDs that include both curriculum and assessment aspects (such as review material related to a skill). A single course could include an elaborate framework of interlocking bricks. Thus, one of skill in the art will recognize that the PSLED blocks can be combined as needed.

These various types of PSLED blocks can be determined through classification. To continue with the above analogy to “Lego” bricks, classification can determine size, shape, and color of individual blocks.

In some embodiments, a PSLED can be broken down into smaller and more discrete PSLEDs. Thus, a cluster of PSLEDs can also be referred to as a single PSLED, and it may be more convenient to treat a cluster of PSLEDs as a single PSLED for some purposes. Generally, when used herein, a PSLED can mean a single PSLED or a cluster of PSLEDs. PSLEDs can be classified and coded at any available level of granularity.

PSLED blocks can also be clustered to focus on certification or credentialing. For example, a cluster of PSLED blocks can be used to define a set of codes corresponding to a credential needed for calculating heat transfer characteristics leading to a design for a heat exchanger. PSLED blocks can also be clustered so that a student can have some flexibility in satisfying the requirements for a credential or certificate by allowing the student to satisfy equivalent PSLEDs to those required using the classification and coding scheme. Students can use earned codes as a form of currency to exchange for a credential or certificate.

Coded PSLED blocks can be clustered to apply skills in cross disciplines. For example, referring again to FIG. 2, both Math 1 and Science N on row 215 require 21st century skill 3 in row 210. 21st century skill 3 can be demonstrated in both PSLED 2 and PSLED 3 in row 205. Thus, PSLED 2 and PSLED3 can be clustered to focus on 21st century skill 3. The clustered PSLED can be classified and coded, the coding corresponding to the 21st century KSAs. Students can learn 21st century skill 3, which may be a math skill, and learn how to apply it in a real world application in a science discipline. Real world applications include hands on problems where students gather, perhaps through research or experimentation, and analyze information through activities to solve problems. Real world skills include 21st century KSAs, such as collaboration, innovation, team work, and creativity.

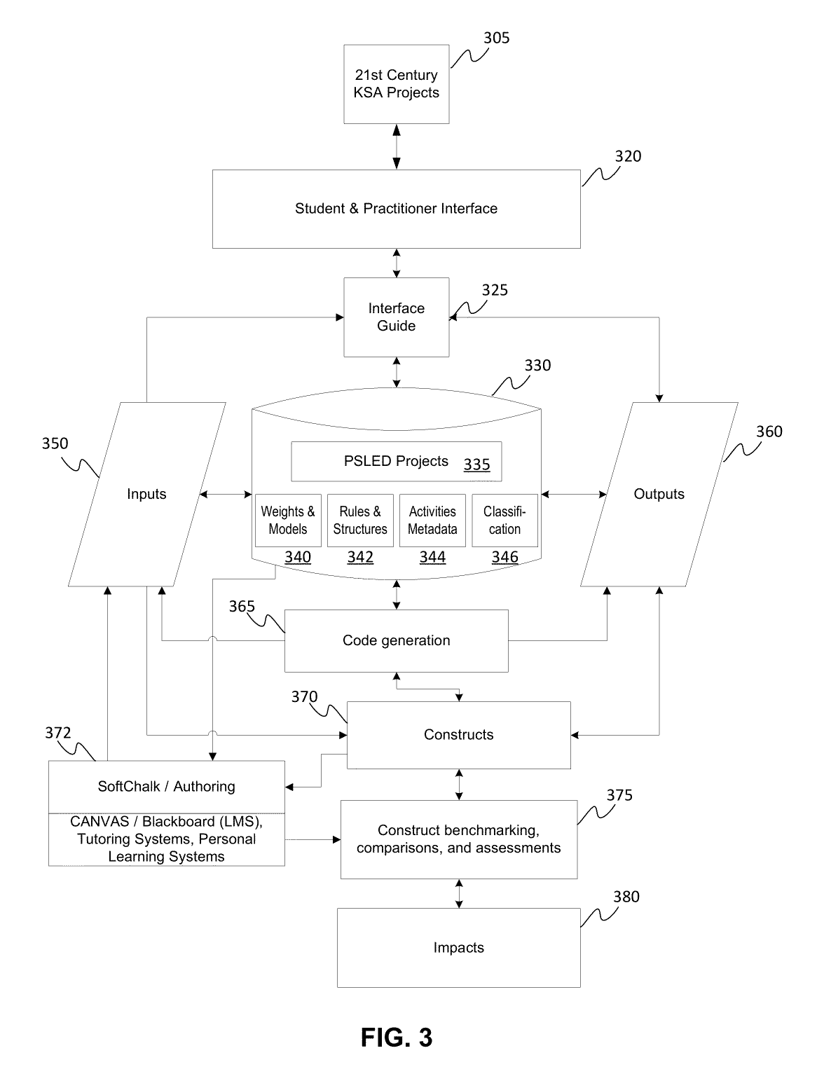

The QMS can organize and control PSLEDs and classifications of PSLEDs in a computer implemented environment utilizing a database, links to databases, other online systems, like personalized learning assistants or tutors or e-portfolio of databases. The QMS can further track and control information related to 21st century KSAs of users. FIG. 3 illustrates a system diagram for a QMS, in accordance with some embodiments, that shows the interactions and forward and backward flow of data and information. A set of 21st century KSA projects 305 can include student work, capstone projects, end of course projects, other course projects, challenges (projects that include problem solving and design within and across courses, and in the case of an e-portfolio, within and across classroom, work, and life experiences.), compositions, or practitioner work. Projects 305 can serve as an interaction input/output for students and also serve as a work input for evaluation purposes. Evaluations are a feedback tool for both the students or practitioners and instructors that can be incorporated into the PSLED or cluster of PSLEDs. Evaluations can inform about whether the student or practitioner has gained the PSLED, and import student or practitioner work into the QMS through evaluation results. Teachers, instructors, mentors, peers, and supervisors can all be part of the evaluation process in an interactive, real-time, or delayed process.

The modules and processes available in the QMS 16 can be used to create an individualized education and career plan. The QMS 16 can maintain the same chains of reasoning in individualized plans of two students with similar education or career goals with different paths but with the same chains of reasoning by mixing, matching, and scaffolding different PSLEDs that are individually selected based on each student's profile. The QMS process can align an individual's—or population of individuals'—educational belief model to other educational models (e.g., the Social Cognitive Career Theory (“SCCT”), discussed in further detail below) which can be applied for the development of both educational and career plans. These individualized plans can then be used as a guide by the student, the instructors, and case managers to facilitate the progression of learning activities onto: 1) the most educationally appropriate and learning goal pathway; 2) the use of available instructional and guidance tools sets (classroom and online, counseling and guidance) available; 3) the learning, practice and guidance pathways to achieve career and workforce aspirations; 4) other professional development activities that advance career opportunities; 5) common definitions to facilitate sharing of information (e.g. open source); 6) create algorithms for predictive analytics; and 7) customized reporting (e.g. such as for admissions)

A student and practitioner interface 320 provides mechanisms for students and practitioners to interface with the QMS 16. For example, interface 320 can include text, graphics, audio, video, computer-aided design, surveys, and others. Interface 320 can be a customizable interface based on preferences of the student or practitioner, including layout and design, or based on the educational and/or focus of the student or practitioner, such as interest in the selection of PSLEDs, clusters of PSLEDs, or a training program. Interface 320 can include an adaptive assessment process, an adaptive feedback process, and an adaptive way to facilitate interactions between students, teachers, peers, mentors, supervisors, parents, and others. Interface 320 can be facilitated by an electronic device such as a computer, tablet, or mobile device. An interface guide 325 can provide a learning environment to present the information to the students and practitioners. Interface guide 325 can include high-level conceptualizations of the organization of PSLED blocks, such as learning and teaching rubrics, as well as more practical considerations such as a visual course layout. Interface guide 325 can also include scoring keys and produce customized front-end experiences for users based on profiles of students and practitioners. Interface guide 325 can also assist in integration with learning management systems such as “CANVAS,” “Blackboard,” “Moodle,” “SoftChalk,” and others that can include any manner of online courses, online tutoring, online personal learning assistants, and other systems designed to assist and augment student learning.

Interface guide 325 can also contain a roadmap like set of guidelines, protocols, and exemplars for the developers of Learning Management, authoring systems, or tutors to create standardized templates and formats. Standardization can promote environments like open source. Through standard codes and processes to certify education and training, QMS 16 lays the foundation for the development of common, open source products, through standardized codes, processes, and a building-block-like approach. Block narratives can form ‘stories’ that can be complied into books, since QMS 16 has a common language structure. One example is aligned rubrics that can be built upon from the smallest unit level to a full-blown course of study.

A QMS database 330 stores and manipulates PSLED related information based on information gathered. For example database 330 can store one or more PSLED projects 335 that include activity information tied to PSLEDs. Processes associated with database 330 can manipulate PSLED activity information through analysis of the information, and provide and store feedback based on the analysis. The analysis can be done in real-time (e.g., as information is received by database 330), at intervals (e.g., nightly), or at milestones (e.g., course completion). Metadata (not shown) associated with PSLED projects 335 can also be stored and used in real-time analysis, or archived for later analysis or data mining. The metadata can specify expected data fields for a PSLED project and can hold data for individual students and practitioners for each project and activity attempted. Metadata can also specify the mentors, peers, or others that the student has interacted with.

Metadata can be mined and manipulated through any known techniques. In particular, metadata can be analyzed to gather and classify generalized information by scrubbing data. Scrubbed data can produce new aggregated data sets that can guide the development, research, or confirmation of models (e.g., confirming a learning and career plan is effective within or across similar students or cohorts of students). Metadata can be analyzed to create demographic trends and modeled to predict outcomes. Employers can use metadata available individually or across a group of workers to develop and clarify the steps needed to achieve a job performance goal or job promotion. Employers can use metadata from groups to help define milestones and then use metadata from individuals to classify where the individual is in relation to milestones and to determine what training or experience (or other KSAs) the individual needs in order to achieve the next milestone.

Weights and models 340 can be developed for each activity for the purpose of evaluating and assessing activity results. Weights and models 340 can also be used to provide variable weights for activities in the overall assessment process. Rules and structures 342 can be developed for each activity to provide a framework for the activity that is passed through interface guide 325 for presentation to students, practitioners, instructors, and mentors and is also passed through to a constructs phase for evaluation and assessment purposes. Rules and structures 342 can also assist in developing rubrics for courses. In addition to the metadata described above, metadata 344 associated with the activities can be used to store information about activities that is passed through interface guide 325 for presentation to students and practitioners or to a constructs phase for evaluation and assessment purposes. For example, metadata 344 can change from one PSLED version to another PSLED version. Data mining techniques can be used on database 330 to assess and diagnose 21st century knowledge, skills, and abilities across the areas of college, career, and workforce readiness, in areas such as teamwork skills, problem-solving skills; critical thinking skills; communication skills; and skills for the integration of science, technology, engineering, and mathematics. For example, data mining can be used to map out the next academic, training, career plans or life skills that the student should develop, learn, or apply. Classification 346 provides classification of PSLEDs, clusters of PSLEDs, or courses. Classification is discussed in further detail, below. Metadata 344 can be used to refine a course or PSLED through different iterations.

Inputs 350 include knowledge based inputs from teachers, faculty, mentors, and trainers with experience in various particular PSLEDs. Inputs 350 can include gathered data through psychometric tools, such as surveys and questionnaires. Inputs 350 also can include other databases relating to PSLEDs. In some embodiments, QMS database 330 can be understood to represent the e-portfolio of PSLEDs for a particular user, with each user having its own interface, such as interface 320, where KSA projects 320 are accessed. Inputs 350 can also include items from external data sources such as cloud-based sources, including test scores or transcripts originating from PSLED or non-PSLED based training curriculum. Workforce related data can also be inputted. Data available by inputs 350 can be mined using data mining techniques to include in QMS database 330. Inputs 350 can also include interfaces for facilitators including teachers, instructors, mentors, peers, and supervisors to provide feedback for students and for case management including interacting with each other to support the mutual development and evaluation of the student. Such interfaces can provide for both real-time and delayed interactions among facilitators and students, individually and in groups. The case management can also include the coordination of services and individuals to the benefit of the student, such as focused interventions by mentors or peers or counselors or parents or others.

Outputs 360 include the transfer of knowledge and data to students, parents, teachers, faculty, mentors, and trainers for evaluation and growth. In some embodiments, outputs 360 can also include data transferred to and from other portfolios, online tutors, personal learning assistants, and cloud-based information systems, PSLED databases. Outputs 360 can also include transfer of data to external data repositories, such as cloud-based storage areas. Outputs 360 can also include reporting diagnostic 21st century KSA assessments or equivalent test scores to legacy systems. Outputs 360 can also include interfaces for facilitators including teachers, instructors, mentors, peers, and supervisors to provide feedback for students and for case management including interacting with each other to support the mutual development and evaluation of the student. Such interfaces can provide for both real-time and delayed interactions among facilitators and students, individually and in groups.

Outputs 360 can include custom reporting, such as for resumes, presentations, and data analysis respective to peers, admissions officers, mentors or other information to highlight a student's or group of students' work and progress towards career aspirations. Custom reporting can also include billing reports that can integrate to known billing systems. Billing can be based on student learning and tasks, student performance, student competencies, and can support student educational loans that are based actual achievements to learning plans and career aspirations. Custom reporting can also include reporting features based on the analytics and data gathered. For example custom reporting can include not only functions like admissions or promotion to the next job level; but also equivalency of testing comparisons, such as reports that show the student has covered and demonstrated competencies in specific KSAs, and therefore can receive some level of ACT or SAT credit, or note some proficiency against local, state, and national government standards.

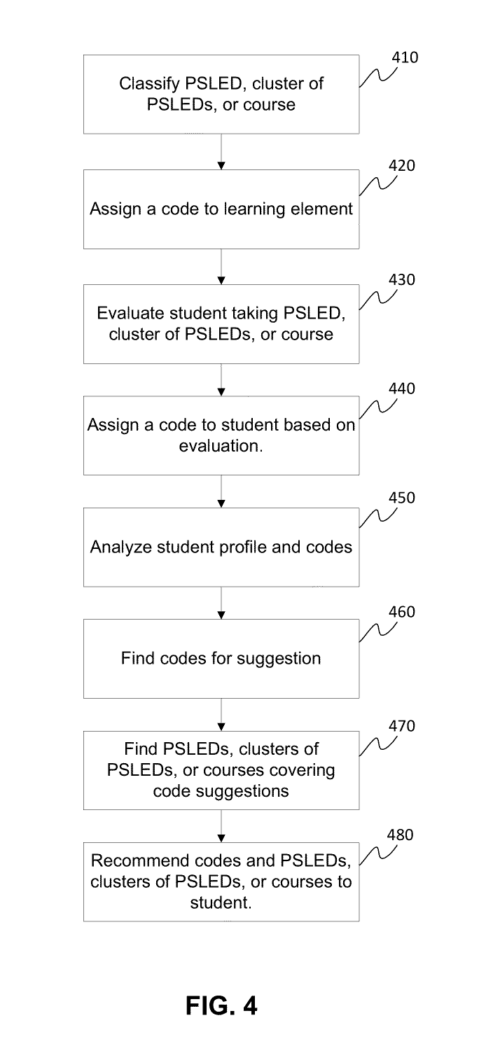

Code generation 365 can occur to classify PSLEDs, courses, or other learning units based on the data in 330, such as project data 335, weights and models 340, rules and structures 342, activities metadata 344, and classification 346. Code generation 365 will likely rely heavily on classification 346, but can also incorporate information from external inputs 350 and provide code information to outputs 360. Code generation is discussed in more detail in conjunction with FIG. 4.

Data analysis can use constructs, such as constructs 370, to perform cross-sectional modeling and prediction of skill profiles. Skill profiles can be modeled relating to design, problem solving, Common Core Standards of Mathematics Practice, Next Generation Science Standards, career clusters, college readiness, career readiness, and workforce readiness. Constructs 370 can distinguish between cognitive, applied practice skills, and other diagnostic analysis. Attributes including problem solving, creativity, communications, and teamwork can be evaluated against different rubrics depending on the goal of the student. For example, such attributes can be evaluated as aligning to college readiness attributes. Other examples include career readiness and workforce readiness. At elementary education levels, such attributes can be evaluated as aligning to progression attributes for an age, grade level, or other classification of a student. At professional education levels, such attributes can be evaluated as aligning to managerial attributes (or subject-matter expert type attributes), working with and collaborating with others, and creative skills to innovatively solve a problem. Constructs 370 can take inputs from inputs 350 and deliver outputs to outputs 360. Educational models 372 include course authoring tools such as “SoftChalk” and learning management systems such as “CANVAS,” “Blackboard,” and “Moodle,” personal learning systems, and tutoring systems, such as mathematics by “Carnegie Learning” and adaptive mathematics tutoring. Data from database 330 and constructs 370 can feed the educational models 372.

Information from constructs 370 and educational models 372 can be analyzed by using benchmarks, comparisons, and assessments at 375. Construct analysis 370 can feedback to constructs 370 to provide to outputs 360 or provide to QMS database 330. Benchmarks can be used to determine whether certain goals have been met through the QMS. Comparisons can be used to compare different students or compare different PSLEDs for one student. Such comparisons may include comparisons of the instruction that the students received, mentoring and mentors, and projects that have the same or similar PSLED maps to those of other students. Assessments can provide a check on the PSLEDs and QMS system to analyze the effectiveness of PSLEDs across samples of students, teachers, trainers, assessors, mentors, peers, parents, and programs. The information from the QMS can also guide the development, configuration, and implementation of assessments tailored to an individual student or cohorts of students; or on a particular ‘risk pool’ requiring certain targeted interventions. The information can also be used to guide the development, configuration, and implementation of assessments tailored to mentors, instructors; and the delivery modality of the content, and activity to the student/cohort.

Various impacts of these benchmarking, comparisons, and assessments analysis in 375 can be assessed at impacts 380. Examples of considerations in design impacted include: PSLED independent developers, project-based assessments, transferability of credit, college admissions, competitive awards, degrees, academic and workforce advancement, 21st century skill credentialing, 21st century skill certifications, institutional 21st century skill accreditation, tutoring programs, apprenticeships, and mentoring programs. Each of these may be impacted, for example, by constructs from the QMS system. Impacts can also encompass further data mining to assess information about the status of students, for example to provide profile information to colleges for admissions purposes, to analyze student's existing training and suggest additional for students, and to analyze available PSLEDs and create new PSLEDs based on skills. Impacts 380 can also include the analysis of prior workforce experience that can be aligned to a PSLED or cluster of PSLEDs so as to award credit for prior workforce related activities. For example, a skilled job such as HVAC technician or network engineer typically carry, not only on the job training, but hands on experience that can be parlayed into PSLED credit based on real world experiences. In particular, active duty or reserve military personnel may receive extensive training and more importantly extensive real life workplace experiences that can be quantified using PSLED blocks or clusters of PSLEDs to award credit to personnel. Analysis can be aligned to classified PSLEDs.

Thus, a QMS, such as QMS 16, can serve to progressively research, develop, and test interfaces, functionality, and principled assessment strategies including reporting mechanisms. The QMS system and the application of specific models of PSLED development can enable the development of task sets and banks, sets of evidence identification and accumulation rules, reporting formats, as well as data-collection, management, and analysis protocols. The QMS system of FIG. 3 can quantify student 21st century knowledge, skills, and abilities within the context of a complex engineered system framed by Evidence Centered Design principles. The QMS system utilizes the data and information that students, practitioners, and others submit to the e-portfolio databases or other online databases, such as databases associated with personalized tutors, content tutors, and learning assistants. By incorporating Evidence Centered Design, the QMS system can provide a methodologically framework to create pathways for data mining and psychometric and diagnostic assessment methods along with design-based research around human interface construction, database management, reporting mechanisms, program development and implementation, selection of students, optimized training for teachers and instructors, and emerging cloud compliance schemes.

The QMS system can use the framework of FIG. 3 and a processor to automatically assess PSLED activities by students and practitioners over interface 320 by processing PSLED projects 335 according to their weights and models 340, rules and structures 342, activity metadata 344, and classification system 346. Constructs 370 and benchmarking 375 can determine which PSLEDs have been satisfied and output at 360 credentials establishing proficiency in PSLEDs or clusters of PSLEDs. Automatic and adaptive assessments can be done for both students or practitioners and teachers or instructors.

The QMS system can use the framework of FIG. 3 to track the accumulation of classified and coded PSLEDs for individual students, practitioners, workforce, employees, and skilled workers (including military or former military members). The QMS can be used to guide the development and testing of assessments, such as SATs and ACTs. The QMS can also be used to integrate 21st century skill, knowledge, and abilities evaluations into AP tests, and to use data obtained from the student from their ‘data repositories’ of PSLEDs (which have a uniform coded structure) to award virtual ACT, SAT, and AP credit based on a students' body of work. In essence, processes used in conjunction with the QMS can lead to the development of new formats and structures for ACT, SAT and AP tests; and programs to prepare for (e.g., through Case Management) tests, including workforce competency and training test systems. The QMS can also be used to more readily compare student's performance across tests that are based on the processes or codes developed by the QMS. One advantage of common codes, is that performance based tests or exams, like an ACT or SAT, can be not only compared, but can be broken down into specific KSAs addressed, which would facilitate their ‘diagnostic’ applicability for case management. Students can pre-earn a SAT or ACT-like test through their ‘library’ of collected and authenticated codes. The QMS can also provide for customized assessment plans that can be effectively equivalent for comparison purposes. For example, an SAT or ACT test can be customized to the individual, removing inherent biases, yet test results are comparable to other students based on the chains of reasoning created and the coding structure.

PSLEDs and non-PSLED learning units can be organized by topic, content, practice area, or any other available organization. In addition, the QMS system can develop unique certificates and credentials based on the achieved PSLEDs (described in further detail, below). In addition, the QMS can align certificates and credentials to existing PSLEDs to award PSLEDs to users based on already achieved certificates and credentials. The QMS system can compare codes for achieved PSLEDs with codes for other available PSLEDs and identify available PSLEDs (or build customized PSLEDs) to demonstrate other related competencies to achieve other codes. The QMS system can identify codes related to new job skills associated with PSLEDs and suggest those PSLEDs or custom PSLEDs codes that need to be earned to demonstrate achievement in a new job skill. Such new job skills can then lead to new job opportunities.

PSLEDs and codes can be used to create human resource guidelines and protocols for hires and promotion. For example, a company may list the codes or code clusters required for a specific job classification. The company could also list the codes required to advance to a new job classification within the company.

Other embodiments of the QMS system can, using similar approaches as those discussed above and discussed in additional examples below, be implemented to achieve other benefits, such as one or more of the following:
establishing a ‘chain of reasoning’ between students' depth of understanding, the evidence that demonstrates their understandings, and the assessment tasks to quantify their understandings;
creating different representations of a ‘chain of reasoning’ to expand a PSLED for different learning styles and for different venues—Algebra I classroom versus online;
interconnecting and aligning the various modalities of assessment;
integrating and expanding the overall QMS system to any kind of learning;
creating individual PSLEDs and clusters of PSLEDs related to progressively learning a specific 21st century skill or clusters of skills;
establishing ‘chains of reasoning’ and practicing to establish equivalency of credit between PSLEDs, representations and expressions of PSLEDs, learning already acquired, and delivery PSLEDs through different venues;
establishing the ‘chains of reasoning’ for different job classifications, thus setting code standards for different job classifications that can be mapped across industries based on building from the ‘bottom’ up through the process inter-linking the educational models through PSLEDs;
establishing a system to develop and align PSLEDs across the curriculum not only for science, technology, engineering and mathematics (“STEM”), but also for subjects including English and the social sciences, e.g. stressing the design process;
allowing a flexibility of practice to align the units and PSLED to the most appropriate standards, and as standards change, the chain of reasoning and evidence to modify a PSLED to align to the new standard;
guiding the implementation of a PSLED over a wide range of venues, including flipped classrooms (classes that use a video (sometimes viewed at home) as the main instruction with in-class work based on the lecture), online courses, and blended learning;
providing a standard approach for independent developers to create PSLEDs and elements of PSLEDs;
providing a structured system to incorporate technology;
providing a standard methodology to create professional development processes tailored to different levels, e.g. teachers and trainers of trainers;
providing a system to train and certify independent developers of the units;
providing a model to create and align technologies to deliver the units, including the creation of apps for the iPhone, iPad, or other tablet or smartphone, or applications for a Microsoft platform;
allowing for a chain of reasoning to create tailored micro-credentials for professionals;
allowing for a chain of reasoning to create tailored micro-certificates for academic and workforce training programs;
defining a system to refine/redefine AP/College Boards programs and GED programs through the micro-credentials and micro-certificates;
providing compatibility with textbook supplements or on-line games for problem solving;
impacting online courses by creating PSLEDs and clusters of PSLEDs that are based on an established chain of reasoning for equivalency of credit;
providing a flexible system to include real-world problem solving examples across a range of disciplines, such as energy, engineering math, and additive manufacturing;
providing a methodology to align assessments for diagnostic purposes from the individual student to cohorts of students;
facilitating on-line or artificial intelligence based teaching tools;
diagnosing weaknesses in teacher backgrounds and allowing for their correction before a teacher uses a PSLED;
extending the use and application of e-portfolios;
structuring information into and out of an e-portfolio;
integrating with existing learning management systems, such as “CANVAS,” “Moodle,” “SoftChalk,” and “Blackboard”;
complementing and supplementing the “Carnegie Unit”;
supplementing and enhancing high stakes tests, like the “SAT” and “ACT” tests;
classifying PSLEDs and associating codes with PSLEDs;
tracking codes for completed PSLEDs for individuals;
suggesting available PSLEDs to individuals or groups based on the classification and coding of PSLEDs earned by individuals or groups;
developing user profiles that include personality traits of individuals (including for example “Myers Briggs” testing or similar techniques, self-efficacy, KSAs, attitudes, opinions, and beliefs), and suggesting courses or PSLEDs based on classifications of PSLEDs or courses and the personality traits of users; (personality can also be based on identified gaps through the system, including identifiers of non-compliance or struggle with education plans, or the identification of no clear education and/or career plan;
developing user profile attributes based on the accumulation of certain types of codes, e.g., identifying a user as a “problem solver” based on the types of codes that have been earned;
maintaining currency pools for individuals where individuals can “buy” credentials or certificates using the codes they have accumulated;
classifying and coding non-PSLED based courses and activities;
scaffolding progressive learning to be both instructional (e.g. classroom based) and case management directed;
aligning the standards through educational models for the students (e.g., UbD, UDL, ECD, and SCCT) to minimize confusion, and to effectively guide the training of the teachers and instructors;
developing processes that can be used by online developers to create artificial intelligence algorithms;
engaging students and connecting them to learning environments through a continual diversity of learning opportunities;
scaffolding Rubrics, taxonomies, and other hierarchical classification models to encourage learning with the integration of technology to fully utilize process to create and align, and then capture data; and
guiding the development of career plans that incorporating academic plans and pathways.

In addition to managing and implementing PSLEDs, as discussed above with respect to FIG. 3, a QMS system, such as QMS 16, can be used to develop and classify PSLEDs. PSLEDs can include of blocks of curriculum, instruction, assessment, or professional development. PSLEDs can be clustered together to produce unique and customized course offerings. The QMS system can use known educational models, ECD, UbD, UDL, and SCCT to create, align, and classify the PSLEDs. Other educational and training models can be used also. Development of PSLEDs is discussed in detail in U.S. patent application Ser. No. 14/190,073. Using similar and compatible techniques, PSLEDs can also be classified and coded. For example other models can be used, such as the SCCT can be layered, or incorporated, or used in part, as appropriate and needed, to incorporate career aspirations.

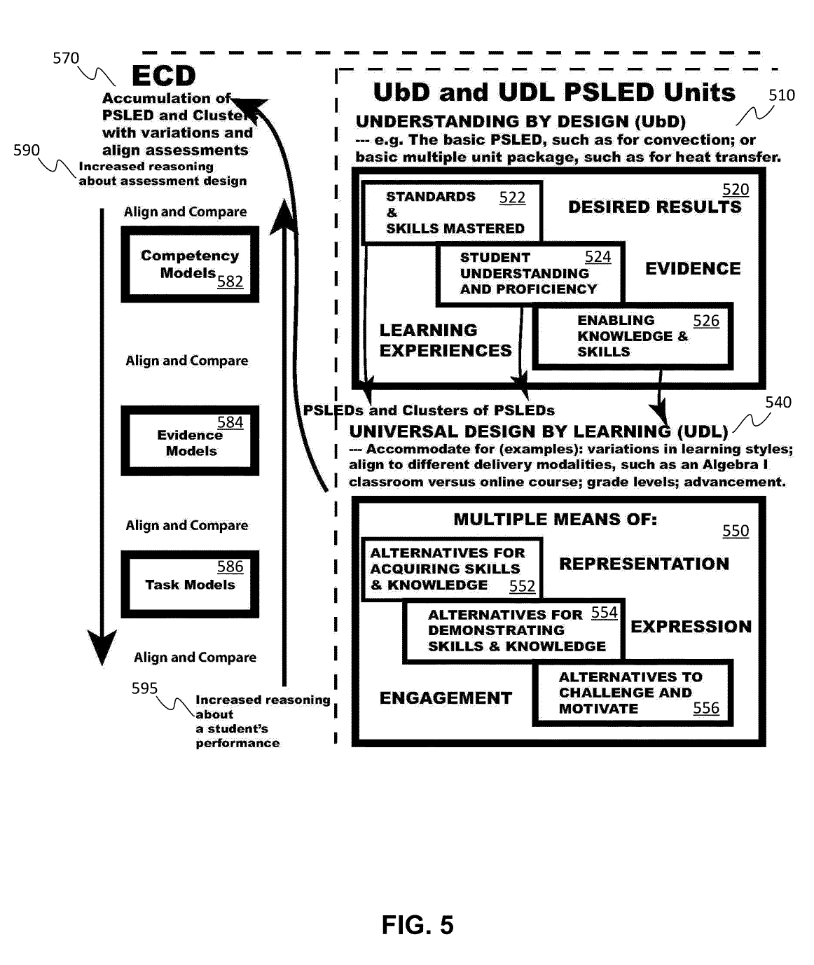

FIG. 4 is a flow diagram illustrating courses that are classified and coded, codes that are assigned to students, and courses that are recommended to students, in accordance with some embodiments. In some embodiments, the functionality of the flow diagram of FIG. 4 (as well as FIG. 5), is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software. A course can receive a classification based on the content of the course. This could be referred to as an Academic Career Instructional Terminology (ACIT) classification. Another classification can be based on evaluation models for the course. This could be referred to as an Assessment for Academic and Career Classification (AACC). The process of developing these classifications is described in detail below with regard to FIG. 5. Other classification models can also be used that can classify PSLEDs, courses, and students based on other theories or models. The examples discussed involving ACIT and AACC classifications and coding are merely illustrative and can be expanded on by one skilled in the art using these examples. One of skill in the art will understand that codes developed and assigned for a classified PSLED or course can include one or more sequences, each representing a particular aspect of the PSLED, course, performance, course context, or other aspects. Much like a vehicle's vehicle identification number (“VIN”), different parts of a complete code sequence can correspond to different meanings related to the classified course content.

These codes can be assigned to each of the classifications and a combined code can represent a course taken and an evaluation of the performance in the course. These codes can represent the courses, subjects, and skills earned by a student, practitioner, teacher, or professional. Codes can also represent classifications that were developed by other theories or models, such as the SCCT model or other models to provide customization of learning environments based on behavioral, physical, or attitudinal attributes. In addition, other coded sequences can designate, for example, a Rubric code that maps a rubric relative to other rubrics, so that the various maps can be aligned and ‘fitted’ with other maps—like longitudinal and latitudinal coordinates are used to align different maps. Further, a code series, or segments of codes, can be used to designate particular learning environments, such as home school, after school, competitions, tutoring, or apprenticeships. The database at 330 can store classification and code information for courses and students.

Referring again to FIG. 4, at 410, classification of a PSLED, cluster of PSLEDs, or a course is done using the module 346 of FIG. 3. Smaller, more discrete units of study can by classified at the ‘atomic level.’ Returning to FIG. 4, at 420, a code, such as an ACIT code, is assigned to the subject learning element (PSLED, cluster of PSLEDs, or course, etc.). The assigned code can be a single code representing an entire course or can be a stacked code, representing each coded concept in a course or training program. At 430, a student is evaluated, for example at the end of a PSLED presentation or course. At 440, a code, such as an AACC code, is assigned to the student based on the evaluation. If the student passed the requirements for the PSLED or course, an ACIT code is also assigned to the student. One of skill in the art will understand that “course” includes any learning unit including a single topic, lesson, or unit of a course.

Other aspects of case management begin at 450, where the system analyzes a student's profile and codes earned. The student profile can contain information regarding physical indications, particular strengths and weaknesses, student preferences, psychometric testing, personality testing, and input from peers, parents, teachers, supervisors, and mentors, and codes associated with KSAs learned and verified on the job. At 460, related or missing codes are found for suggestion to the student. These can be found by comparing a listing of codes to a requirements specification for a particular credential or certification. Codes can be generalized to find related classifications that could substitute for a code. At 470, PSLEDs, clusters of PSLEDs, or courses covering the code suggestions are found by looking up the code in the database 330 to find the courses associated with that classified code. The courses found can be cross-referenced with student profile information to eliminate or highlight particular courses with respectively low or high compatibility. At 480, recommendations are prepared and offered to the student. The codes found in database 330 can take into account the progression of learning, tools used and applied, the rubric used, the language used, the results from the assessments, whether psychometric surveys and questionnaires where used, the time required to demonstrate competencies, whether the activity was in the classroom, in a flipped environment, with a third party vendor, such as “Sylvan Learning,” or learned through an online course or activity, or through a mentoring program, or learned digitally on an smart phone, tablet, or computer, etc. The codes can also take into account the abilities of the student, e.g., blind, deaf, special needs, or special education student. The codes can be to modify an assessment (maintaining the chains of reasoning) based on the learner. For example, for a given instructional PSLED activity a blind student, the UDL component can map to an equivalent PSLED activity executed by a sighted student. Thus, individual schema and adaptive schema can be created for students and other learners so that case managers can guide the learner across courses of study, learning styles, and trajectories of learning.

Code structures can be designated for different uses. For example, for a particular course or PSLED, different code structures can denote aspects that include: instruction, assessment, mentoring, professional development, training authority, learning management, tutoring, etc.

Coding models can be used to create new processes or templates for processes. For example, in the development of Rubrics, or authoritative rules which are often used to grade or assess a student's work, database 330 of FIG. 3 can be used to develop and guide the development of Rubrics, and the progressive layering and nesting of Rubrics. For example, Rubrics can be developed and layered through input from weights and models 340 and rules and structures 342. Through metadata mining 344 and classification 346, Rubrics can be honed and layered based on identified needs. Rather than being developed in isolation, Rubrics can be developed using the same principles from the PSLED and classification process to achieve the ability to map Rubrics to each other. Through the classification and coding process, for example, codes can be used to develop, align, and layer Rubrics used in the assessment of students.

A Rubric in its simplest form includes a task description, a scale of some sort (e.g., grades), the dimensions of the assignment (a breakdown of the skills/knowledge involved in the assignment), and the descriptions of what constitutes each level of performance. In contrast with known systems, the PSLED process can create individual Rubrics that can then be inter-connected and aligned in chain of reasoning with other Rubrics created by the PSLED process—each Rubric can have a coded designation which with the other segments accounts for the tasks, scale used/applied, dimensions of the assignments (e.g. problem solving, team work, collaboration, etc. relating to 21st century KSAs), and coded indicators related to student performance.

The coded structures created by the PSLED process can have a segment that outlines the Rubric. The coded segments can readily identify key attributes of a given Rubric, and how it might be used as a ‘coordinate’ segment of a map, that when combined with other coordinates, piece together a ‘topological’ map of student learning, much like maps for a certain region that can be aligned to another map of an adjacent region, and aligned through longitudinal and latitudinal markings. Each map can have a set of defining characteristics that can be used to align to other maps, or can be used to show similar features, like rivers and the depths, and mountains and their heights. Codes can build the logical ‘welds’ between the chains of reasoning or the map coordinates that align segments of the learning maps for each student. Thus, progressively inter-related Rubrics can be built that will, when pieced together, create the ‘road maps’ for the instructional plans to be relate to student learning and outcomes across ‘geographies.’ Codes can be the inter- and intra-connective ‘roads’ on the map that can lead to equivalency of learning and assessment for academic and job related credit.

Using the flow diagram of FIG. 4, the cost of providing education can be reduced by providing education modalities and content that are designed to be more effective for individual learners. Case management by recommending particular courses or course sequences, students can find success where little was found before. Success can lead to lower costs for the student, lower costs for the school to teach the student, and a higher income for the student because the system can lead to student better performance. The course, training, or PSLED recommendations can account for the personalities of the student, or when interventions are appropriate, such as mentoring or tutoring. Where a student may learn best in a “flipped” learning environment, a suitable course can be recommended. The system can even mine data from past courses and determine the type of modalities and content that would likely be relevant and effective for a particular student. The system can then recommend only the courses which may be effective. Case management might also lead to other recommendations, such as switching to another career aspiration, applying for scholarships based on the KSAs demonstrated, and other guiding modifications to an education and/or career plan. Another aspect is that the codes can be used to identify certain attributes, such as a “problem solver” or “team player” based on the accumulation of specific codes.

Classification and coding can also be used for:
Connecting and aligning benchmarks to prepare and assess students within K-12 education (e.g., CC/NGSS), courses of study (e.g., AP classes), and interventions.
Laying the foundation for universally accepted credit regardless of whether the knowledge and skills come from the classroom, from self-study, from home schooling, from extra-curricular, or online. Codes can facilitate the mapping between domains and experiences.
Identifying gaps, and creating the chains of accountability—supported by Rubrics for example—for students to gain recognition and credit.
Facilitating and encouraging independent developers to align curriculum, instructional delivery systems, and assessments—including those for different intents, for example online tutors, personalized learning assistants, authoring tools (e.g., SoftChalk), learning managements systems (e.g., CANVAS), etc.
Coding and the foundational PSLED process can facilitate and guide the development and the use of common data definitions such as through groups like Creative Commons.
Coding and the foundational PSLED process can facilitate and guide the development, the standardization and alignment of open source systems, such as the “Open Source Project” by “Sinclair College Student Success Plan.”
Coding and the foundational PSLED process can facilitate and guide the development of the use projects, like the “Educause ECAR” study on “Integrated Planning and Advising Systems” (“IPAS”).
Coding and the foundational PSLED process can facilitate and guide the development of new human resource guidelines and protocols for new hires and/or advancement within a company or organization.
Coding and metadata derived from worker profiles can be used to provide workers with experiential and training goals to achieve milestones necessary for advancement, bonuses, raises, etc.
Impacting online courses by creating and coding PSLEDs and Clusters of PSLEDs that are based on established chains of reasoning, and maintaining rubrics to create a foundation for equivalency of credit.
Providing a methodology to align assessments for diagnostic purposes from the individual student to cohorts of students.
Structuring information into and out of a diversity of systems, including e-portfolios, learning management systems, tutoring, personal learning assistants, and systems associated with online courses.
Indicating a degree of difficulty or student learning barriers overcome or needed to overcome to progress.
Creating a new way to value education from both a monetary and credit perspective.
Organizing and categorizing “collective” knowledge from the cloud.
Developing ACTs, SATs, and Aps aligned to specific codes.
Developing strategies for career aspirations and/or advancement based on the codes achieved, the gap analysis to achieve a academic and/or career aspiration.
Identifying the cross-walks between learning activities and workforce related training.
Enforcing governance and standards settings within an educational system.
Helping to overcome the disconnect between credit-baring and non-credit baring opportunities.
Addressing tuition cost increases by modularizing programs and charging tuition only for the codes required.
Streamlining financial aid considerations by modularizing programs to relate financial aid to minimum number credit hours (or case coded learning or career units).
Streamlining and scaling processes for awarding credit to accommodate rapid growth.
Creating lattice credentials that provide credentials from cross-disciplines.
Replacing or supplementing high stakes tests (like SATs and ACTs) by using the codes as an ‘ongoing’ repository and process for students/workers to demonstrate success in achieving competencies, connected through the ‘chains of reasoning’ and ‘chains of documentation’ to build their own library which can be readily referenced in lieu of tests, job certifications/or accrediting processes.
Think of re-certification processes, where you need to gain continuing education credits, our process would allow the learner/worker to create their comparable library of reference codes, and submit. The accrediting agency would accept and/or recommend other ‘units’ that must be earned before accrediting.

FIG. 5 is a flow diagram that illustrates how example educational models can be used to classify PSLEDs, clusters, courses, and course segments or units, in accordance with some embodiments. As discussed above, these techniques can be altered to use other learning and career models, such as the SCCT. Thus, although ECD, UbD, and UDL are specifically discussed below, one of ordinary skill in the art will understand that other educational models can be used in place of or in addition to these educational models to achieve similar results.

ECD provides the overarching thrust of organizing PSLEDs and clusters of PSLEDs to achieve chains of reasoning and alignment between skills and instruction. PSLED blocks classifications are generally developed initially using UbD models 510. For example, a basic PSLED can address the concept of convection. A basic cluster of PSLEDs can combine the convection PSLED with other PSLEDs to address the concept of heat transfer. Part of the classification can capture that the PSLED or course addresses convection. In UbD, desired results 520 are identified, including, for example, identifying standards and skills to be mastered 522 at successful completion of the PSLED. Determine targeted evidence of the student's understanding and proficiency 524. These will set the benchmarks for evaluating a student. Identify learning experiences 526 that can provide enabling knowledge and skills that can be later assessed. The classification can identify variances for each of 522, 524, and 526.

The basic PSLED can be augmented by a UDL design 540 to allow for variations in learning styles, variations in contextual forums (such as online versus in-class learning), variations in grade level, and variations in advancement or aptitude, alignment to workforce required KSAs. Such augmentations can also be captured using a classification system. Multiple means 520 of representation can be developed for alternative means for acquiring skills and knowledge 552. Multiple means 520 of expression can be developed for alternative means for demonstrating skills and knowledge 554. Multiple means 520 of engagement can be developed for alternative means to challenge and motivate 556. Each of the multiple means 520 generated in 552, 554, and 556 can provide different classification branches.

Having gone through both UbD and UDL design, multiple PSLEDs could be classified depending on the alternatives created by UDL 540, each representing the same topic or theme, for example convection. Thus, in order to provide a consistent PSLED result across all the alternatives ECD 570 can be used to capture uniformity of PSLEDs and clusters of PSLEDs in the classification regardless of variations amongst them (for each base PSLED or cluster of PSLEDs). Competency models 582 are used to extract and classify aligned competency in the PSLED or course. The competency models can be the same for each PSLED or cluster of PSLEDs, or the competency models can be selected so that each achieves the same result. In other words, targeted student standards and skills for mastery 522 of the basic PSLED can be aligned to have the same competency classifications for an alternative PSLED with variations in the alternative standards and skills mastered 552. These competency models can be classified and administered to achieve a consistent and reliable result among different instances of instruction and evaluation of the PSLED at issue. For example, whereas a candidate for a job may be required to learn or demonstrate competency in multiplying together two three digit numbers, a third grade student may be required to learn or demonstrate competency in multiplying two numbers, each up to the value ten. In this example, these PSLEDs or clusters of PSLEDs can be considered equivalent for a basic premise, but simply variations of each other, but classified to be equivalent at least at some level based on the typed of alternatives developed at 540. Competency models can be used to standardize and to implement interactions with peers, mentors, instructors, and the use or alignment of online tools, such as tutoring, personal learning assistants, and e-portfolios.

Evidence models 584 are developed for each of the PSLEDs for further classification. Each evidence model 584 can be the same for each PSLED or cluster of PSLEDs, or the evidence model can be selected so that each achieves the same result. In other words, similar to the competency models above, demonstrated student understanding and proficiency 524 of the basic PSLED can be aligned to have the same evidence classifications for an alternative PSLED with variations in alternatives for demonstrating the same skills and knowledge 454. These evidence models can be classified and adjusted through evaluation of the PSLED to achieve a consistent and reliable result among different instances of instruction and evaluation of the PSLED at issue.

Task models 586 are developed for each of the PSLEDs for further classification. The task models can be the same for each PSLED or cluster of PSLEDs, or the task models can be selected so that each achieves the same result. In other words, similar to the competency models and evidence models above, student learning experiences 426 of the basic PSLED can be classified to have the same learning effect for an alternative PSLED with variations in alternatives for engaging in the same challenges and motivations 556. These task models can be aligned and compared and adjusted through evaluation of the PSLED to achieve a consistent and reliable result among different instances of instruction and evaluation of the PSLED at issue.

Competency models 590 are aligned to evidence models, and evidence models are aligned to task models through comparison, increased reasoning about the effectiveness of the assessment design can be achieved. In contrast, as task models are aligned to evidence models, and evidence models are aligned to competency models, increased reasoning about a student's performance can be achieved 595. Thus, ECD builds the process (curriculum, instruction, and assessment) foundations of UbD and UDL to extend the chains of reasoning to a coherent (and auditable) assessment strategy, thereby establishing the links in the chain for reasoning to compare the learning, assessment, and ‘credit’ for 21st century KSAs. Classification and codification of these PSLEDs likewise provide for development of these skills.

Using classified and coded PSLED blocks or units or classified and coded clusters of PSLED blocks (or other learning units) as a basis for identifying achievable KSAs, individuals can earn codes that demonstrate their proficiencies and competencies in a PSLED or clusters of PSLEDs based on their performed and demonstrated activities, tools utilized, such as those provided online, or from the ‘cloud,’ guidance through Case Management, or through online tutoring.

In some embodiments, QMS 16 can provide a methodology and a principled approach to cluster coded PSLEDs. These clusters can be organized to offer task focused learning within and across multiple courses for students to progressively study and practice complex and cognitively challenging problems. From an instructional perspective, clustered codes could correspond to PSLEDs and clusters of PSLEDs (or other learning units) to allow progressively more open-ended instruction for teachers or instructors and students or practitioners to achieve the following broad range of learning outcomes:
Social (e.g., cooperative teamwork, and behavioral, as acceptance of the consequences of failure);
Personal (e.g., gaining the self-efficacy to tackle a complex problem and be persistent);
Intellectual (e.g., habits of mind, development of casual, argumentative, and critical thinking skills); and
Appreciation (e.g., procedural approaches, such as the design process).

The QMS 16 can be organized to identify codes necessary to target specific KSAs, e.g., heat transfer leading to a design for a heat exchanger, and cluster those codes. Students can then be evaluated and assessed on competencies related to pre-requisite KSAs for a specific academic or workforce competency—such as for an HVAC technician. Students and workers can also be evaluated and assessed based on psychometric based surveys and questionnaires that can not only be used to gather information on a student or worker's self-efficacy, but also through the demonstrations and performance in context of a PSLED (or groupings of PSLEDs) the student or worker's demonstrated confidence, motivations, etc. Students or workers can use codes to earn micro-certifications from teachers that have micro-credentials in that cluster. Codes can be assembled for career guidance and individualized instruction for both students contemplating the workforce and workers in the workforce. Codes can be used to create new human resource guidelines and protocols for hiring based on established ‘chains of performance’ documented by an individual.

Teachers and instructors can use codes to earn credentials that demonstrate their proficiencies and competencies to teach certain PSLEDs based on certain accomplishments defined, detailed and tracked by the QMS 16. Mentors and peers can use codes to earn credentials or micro-credentials to perform mentorship or support for students. PSLEDs can be developed specifically for this purpose, or a base PSLED can be varied and coded to include additional measures that would indicate a teacher's proficiency to teach the targeted PSLED. Thus, the QMS 16 can be used to classify professional development models for teachers or instructors and for a train the trainer model. Instructors or teachers may not be able to teach a class without first having been credentialed in the class content as well as further optional class teaching credentials. QMS 16 can align both formative and summative assessments across the various units, thus enabling the longitudinal tracking of individual students and cohorts of students through classification and coding schemes. QMS 16 can assist students in the self-assessments of their trajectories of learning, based on their individual learning plans.

Various classifications of PSLEDs might converge into a model to ‘cluster’ PSLED by specific learning activities, such as the energy concepts of conduction, convection, and radiation (e.g., related to heat transfer) for students and veterans. A separate cluster might be classified for teacher professional development related to the instruction of a given cluster and in context of design, scientific method, and problem solving.

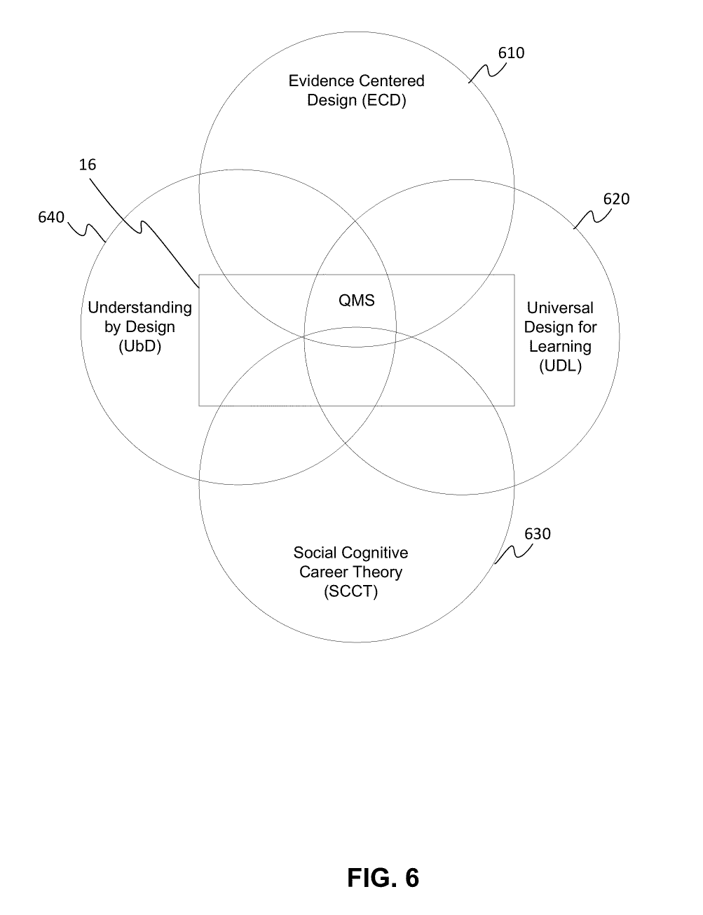

FIG. 6 is a logic diagram illustrating the relationship of the QMS with example educational models. ECD (610), UDL (620), SCCT (630), and UbD (640), can all overlap in a four-way Venn diagram. Each educational model can be used alone or in combination with any number of other educational models. QMS 16 sits astride each of the educational models and can make use of each of the models individually or in any combination. One of skill will understand that these are only examples and one or more other educational models can be substituted or added to present other options.

The SCCT model is a feedback looped process based on the learner's goals and efficacy relevant supports, resources, and obstacles. The model can be fed information gathered, organized, and tagged by the QMS through inputs 350 to track a learner's self-efficacy expectations (the extent or strength of one's belief in one's own abilities to complete tasks and reach goals). Self-efficacy is grounded by the learner's goals and efficacy environmental supports, and provides the learner's attitudinal and behavioral ‘mind-set’ to contend with work conditions and outcomes and to participate in progress of a goal-directed activity. Self-efficacy, participation progress, and work conditions and outcomes lead to work satisfaction. Personality and affective traits, such as extraversion, conscientiousness, neuroticism, etc., also impact work satisfaction. All these impacts together can feedback to impact self-efficacy and goals, creating a feedback loop. These impacts and the feedback loop can become part of the learner's ‘education belief’ models, thereby impacting the learner's education, career preparation, workforce training, and professional development.

Classification of PSLEDs and non-PSLED based learning units or courses and development of PSLEDs under the SCCT model incorporates knowledge about the learner to customize learning models that are designed to be highly successful to the learner. Codes given to a learner under an SCCT classification model can account for personality and education models and inform future course offerings taken by the learner from other institutions or other sources. An SCCT classification model can also incorporate career aspirations and other considerations, such as a learner's attitude and planning.

In some embodiments, from a professional development perspective, middle, high school teachers, community college faculty, and online instructors can be trained to gain specific codes based on demonstrated core PSLEDs and or series of PSLEDs and clusters of PSLEDs, e.g., in context of Algebra I or II, Pre-Calculus, Career Cluster for Energy Generation Technician, or Automation and Production Technology. In addition, a specific teacher (or instructor) centric core PSLED, such as a Design and Scientific Inquiry can be offered to build teacher or instructor skills to provide foundational knowledge in certain domains, e.g., design.

The QMS 16 can be an adaptive system, based on certain identified codes, the course of study not only for the student, but also for teachers, instructors, and mentors can be individualized, personalized, and aligned to career or workforce aspirations and preparation. These ‘educational learning plans’ can be personalized at all levels. Both students and workers can receive individualized plans that specify recommended experiences, classes, or training needed to advance. These individualized plans can constantly be updated to reflect the actual experiences, classes, or training (or any code-earning activity) received by the individual and provide adjustments as necessary to the plan to account for the additional codes received. Human resources departments can facilitate worker advancement and training by tracking worker's codes and career trajectories.

In some embodiments, students lacking a specific code related to PSLEDs or a cluster of PSLEDs can achieve the missing code rather than repeat an entire course. Students lacking particular codes as prerequisites can acquire them by a variety of means (such as in an online marketplace, other learning institutions, homeschooling, or self-study) before taking that portion of the course that requires them. Less time and credit can be lost by transfer students or students who have done non-AP advanced work in high school if their prior units of study or courses are now based on coded PSLEDs. These students would earn codes related to the instruction and understanding of their classes. Thus the new institution can award advancement and credit for coded PSLEDs already achieved at the necessary levels or variations from other institutions. Similarly, if the codes needed for certification for two related trades overlap, a worker can earn two certifications without repeating the overlapping materials.

Similarly, coded PSLEDs can serve as a mechanism to easily facilitate the transfer between institutions. For example, the growing online industry is continually challenged by ‘transferability’ of credit. Students and professionals are not confined to one source of instruction or training. Enrollment is mobile and can move from a local physical classroom to a global web site. Mobile students may desire a diversified education, however, students may find that mobility can be constrained by the ability to transfer credit.

Student can be awarded codes that can serve as an “educational currency” that is normalized and accepted. The codes can serve to represent both a classification of achievement of a PSLED or course and a classification of proficiency in the PSLED or course (the ACIT and AACC codes as described above). As noted above, however, classifications can include additional schemes based on other criteria and awarded as other codes or segments of codes. The codes can also repeat or be related so that a student who has repeated codes earned or codes earned that are similar to codes already achieved can show expanded proficiency in a particular skill. Repeated codes could signify that a student or practitioner has achieved repeated hands on experience or training. A multitude of related codes could signify the same.

The QMS 16 provides a classification system to map equivalency between PSLEDs, clusters of PSLEDs, courses with PSLEDs, and different modalities of learning and delivery. In some embodiments, instructional units (e.g., cluster of PSLEDs on a given topic, heat transfer) can be classified. Some embodiments can classify the entire course (e.g., an Algebra I course with embedded PSLEDs offered in a high school versus community college classroom versus online). In some embodiments, the various standards of learning and practice can by classified and coded within and across PSLEDs. In some embodiments, micro-certificates earned by students based on a progression of PSLEDs clusters can be classified and reverse coded to award students equivalent codes for micro-certificates. Some embodiments can classify micro-credentials earned by teachers/instructors/trainers based on PLSEDs and PSLED clusters. Some embodiments of the QMS 16 can classify certifications/credentials for independent developers, e.g., like the “CISCO academy model” or “Microsoft” certifications—to create and publish PSLEDs.

The QMS model 16 can facilitate transfer by the creation of equivalency maps for classified PSLEDs. Equivalency maps can be created based on standards (e.g., Energy Literacy, Science and Occupational Competencies); big ideas (e.g., topics such as heat transfer); essential knowledge and learning objectives (e.g., Energy Career Cluster skills and knowledge); evidence of understandings (e.g., how the students are assessed to demonstrate competencies); and occupational maps (e.g., “DACUM's” occupational analysis for Wind Technicians). QMS model 16 can further facilitate transfer by assessments that cover the range of constructs important to problem solving, e.g., procedural, cognitive, behavioral, and attitudinal; and the development/alignment of the Rubrics to assess.

In some embodiments, QMS 16 can enable and encourage independent developers to become certified to develop PSLEDs for classification. Classifiers can classify the PSLEDs or clusters of PSLEDs (or other types of courses and learning environments). Developers of PSLEDs can sell PSLEDs or clusters of PSLEDs in a marketplace. Original online resources or those from third parties can be effectively and systematically ‘stringed together’ to create a combined learning experience (e.g., problem solving scenarios) for students to gain a wide breadth of knowledge, skills, abilities, and personal attributes. Such resources can be used to create an integrated Case Management System, as with QMS 16, and can be used to created new coded schema to link and align not only Rubrics, but also educational models, such as the inclusion of the SCCT model. This wide breadth of knowledge, skills, abilities, and personal attributes can be used to rationalize, solve, and develop possible solutions to move from basic to more complex problems which engage different cognitive processes. In addition, known solutions lack metrics to track performance in solving a basic problem that can be used to predict the quality of solutions for more complex problems.

QMS 16 can incorporate a structured system toolset for developers to create and cluster PSLEDs (much like a developer would create and launch a new “iPhone” App). QMS 16 can align PSLEDs, clusters, and other learning environments through such toolsets, as the codes, the development of algorithms, and other translational toolsets to utilize different platforms of delivery to the student, the teacher, the instructor, and the mentor. At the same time, QMS 16 can provide a system to study problem solving, and to create data that can be compared within and across implementation of PSLEDs, student's trajectories of learning, career pathways, workforce job skills, and the professional development of the instructors. As these activities increase, classification and coding processes can allow for developers to follow and execute the QMS methodology, such as that in QMS 16.

As a result, existing resources such as those offered by organizations and companies like “Design STEM” illustrate how Understanding by Design can guide the development of individual units, each aligned to appropriate standards, and presented in a manner that engage students. However, the units are offered in isolation, much like a word problem, and the ‘insertion’ into the curriculum is left to the teacher or the school administrator.

Basing the “Design STEM” units on standards is only one step on the way to the ‘equivalency’ chains of reasoning required to compare units across not only standards, but also learning styles, cognitive reasoning and even communities of learning. QMS system 16 can address all the critical points of comparison to create the unbroken chain to compare units that is standards based, but also allows for the other aspects of problem solving to be assessed.

QMS 16 can also connect other online resources of units by subject area. Most can be considered ‘isolated’ units offered in context of a given course, problem solving situation, or context. Other than standards, there are often no other comparative points. For example, there are not comparative points for connecting learning models fulfilled by online tutors, personal assistants, and e-portfolios.

In some embodiments, QMS 16 can guide the development of classifications for other instructional and professional development road maps for teachers or instructors, including for converted existing available online resources into resources that are aligned, not only to standards, but also to other procedural (e.g. the design process), cognitive, behavioral and attitudinal constructs critical for the broad implementation of PSLED(s). Also, individual PSLEDs or combinations of PSLEDs can be inserted into a textbook or online text source to individualize a student's learning of a topic and corresponding assessment of KSA demonstrated. A case manager can facilitate the insertion into a textbook for a student or group of students. Also, the Case Manager can suggest a particular intervention based on the review of an e-portfolio, such as facilitating the involvement of a mentor to assist in the development of a design, or execution of a design step. For example, an online course for active duty military members can be mapped or converted to a course based on PSLEDs that have been classified and coded, which can allow for an active duty military student to cover and achieve PSLEDs in person on base or remotely while deployed without suffering disconnection between in-person and online learning in the course. The military student can then receive codes for each of the PSLEDs that have been achieved.

A marketplace can convert or track coded PSLEDs and offer other coded PSLEDs corresponding to a particular course to allow users the ability to source course content from multiple vendors. An online interface, such as a web page or a smartphone app that can provide content to a user. In some embodiments, a PSLED can be developed by an independent source, such as through “Design STEM” or “Teach Engineering” and then redistributed as a PSLED. Such PSLEDs can also be classified and coded. Royalties can be paid to the developer when sold as an individual PSLED or as a part of a cluster of PSLEDs. Royalties can be awarded based on codes covered and codes actually earned by students.

In some embodiments, a ‘buyer’ could select from a menu of available PSLEDs to construct a course or a certificate pathway that aligned the block nature of PSLEDs into an ‘academic’ process. A vendor can assess the codes associated with a user and suggest appropriate courses or individual PSLEDs to provide the user the codes necessary to achieve a credential or certificate. An online venue could price the package, and automatically generate an appropriate ‘academic’ credit, micro-certificate, or micro-credential that the buyer's selected menu of PSLED blocks selected would equate upon completion. The vendor can also store information regarding the completed codes belonging to the user. Customization of clusters of PSLEDs can achieve greater flexibility and retention for some students. In some embodiments, the ‘buyer’ can be a student and the marketplace a learning institution, where the student can choose PSLEDs to develop their own curriculum and courses. Degrees or diplomas can be awarded by the institution based on codes, micro-credentials, or micro-certificates addressing different clusters of PSLEDs. In other embodiments, the ‘buyer’ can be a learning institution that selects packaged PSLEDs to develop courses for its students.

PSLEDs and courses can be developed, classified, and coded according to open source available materials. Thus, a broad range of contributors can be available to ‘add’ or subtract PSLEDs to the repository. Codes can be used to identify gaps, and therefore guide the development of new PSLEDs or groupings of PSLEDs. Also gaps in the reported codes, which can lead to the development of new codes.

A QMS system, such as QMS 16, along with its PSLEDs can create a new system to track and award codes associated with an AP Curriculum or high stakes tests. Thus, students can gain certifications for specific 21st century KSAs and sets of 21st century KSAs by completing PSLEDs as an alternative method for individuals to gain advancement and transfer credit. Standardized tests for college admissions, such as SAT and ACT can be supplemented or augmented by inclusion of PSLED assessments and PSLED based codes and certificates that demonstrate an individual's proficiencies and competencies in individual and sets of KSAs. In some embodiments, the chains of reasoning and mapping of KSAs to procedural, cognitive, behavioral and attitudinal constructs represented by achieved codes can be used by professional examinations and credentialing processes to evaluate broader ranges of occupational skills and knowledge sets.

QMS 16 can be applied to classify PSLEDs for a course that has been transformed from a standard course to a PSLED based course by:
Anchoring PSLEDs to targeted knowledge, skills, and abilities to create and classify PSLEDs aligned to real life applications and workplace scenarios for students to progressively learn and practice 21st century KSAs;
‘Unpacking’ the Common Core Standards of Mathematics Practice (“CCSMP”) and NGSS to ‘tease out’ the big ideas and essential understandings of courses utilizing UbD;
Differentiating the curriculum, instruction and assessment within and across PSLEDs to establish problem-solving learning equity by UDL and further supplement classification information; and
Aligning the relevant problem solving evidence over a range of knowledge, skills, abilities, attitudes, and behavioral constructs into a coherent assessment framework utilizing ECD Design and further supplement the classification information based on problem solving evidence.

Using these techniques, the QMS can be used to develop and outline taxonomies or hierarchical classification models to provide maps to scaffold the PSLED (and the elements within the PSLEDs) within a course (e.g., Algebra I), across courses (e.g., Algebra I, Physics), projects and workforce training, and align to standards. As a result, each classified and coded PSLED and series of PSLEDs can have specific assessments that can lead to strategies for structured assessments covering a range of problem solving attributes. The classification and coding scheme of QMS 16 can be applied to embed a range of assessment instruments to capture a range of skills, competences, and proficiencies demonstrated by students within and across PSLEDs through the use of such tools as an e-portfolio or other online tools/resources or “just-in-time” time topics for online textbooks.

For example, QMS 16 can expand the dynamic range of assessments embedded in an e-portfolio database. Such assessments ranging from rubrics to score student work to instruments that track students' problem solving self-efficacy. The QMS 16 can be used to develop and align Rubrics. Therefore, QMS 16 has the potential to be used for not only formative assessments for each problem-solving scenario (PSLEDs), but also as a longitudinal record of student problem- and scenario-solving skills, and changes in problem solving attitudes over a series of PSLEDs. Assessment can be ongoing, cumulative, and real-time. For example, as information that has been tagged, and can become searchable and aligned into a structure through the coded process, date elements can provide assessment feedback for and becomes available from the student, teacher, mentor, supervisor, instructor, etc., the assessment output can be modified or updated with each new information in real-time or at intervals. Rubrics can be stacked, and aligned. Thus creating opportunities to study student trajectories of learning for diagnostic assessment across scenarios, across mathematics and science concepts, across other content areas like social sciences, economics, fashion, architecture, etc., across professional areas, and across end of course, end of year, and end of learning cycle (e.g. pre-college and undergraduate) capstone projects. The QMS 16 can guide the development and implementation of PSLEDs not only for the formal classroom environment and for online courses, but also for informal (e.g. after schools activities) such as student design competitions, tutoring programs (like “Sylvan Learning” or “Huntington Learning Centers”), homeschool, and homeschool hybrid courses.

QMS 16 can be used and applied as a Case Management System for tracking student development with inputs supported from many different sources, such as teachers, employers, mentors, peers, counselors, and parents. The student becomes the “patient” and the QMS 16 as a case management system facilitates the joint development and progress of advancing the student forward, perhaps toward a specific goal like a particular credential or certificate or specific career plan or workforce job level. Case management can cover both student academic and career guidance, and teacher or instructor training, including mentors or other practitioners. Case management can cover an individual's mobility within the workforce, to guide the development and demonstration of skills to move up in job classifications. Case management also facilitates the encouragement of a common coding system and the implementation and utilization of modalities of assessment. Case management can allow various modalities of instruction and training to implemented and assessed, and tracked across different users and cohorts of users. Case management can apply and align PSLEDs for different learners and cohorts of learners, across learning environments for continuity and progressions of learning. Thus, through case management, QMS 16 can be expanded across educational and workforce domains and boundaries—from Kindergarten through workforce.

Case management can be adaptive to the learning or communications setting. So students can be handled according to whether they learn in a traditional environment, a flipped environment, a tutoring session, homeschool, mentorship, or digitally through an online course on a computer, smart phone, or tablet. Case management can facilitate self-regulated learning appropriate for the individual. Screening can be done, based on psychometric surveys, coding, and other analysis to conduct educational risk analysis.

Common Case Management templates, guidance resources and scripts can be developed through the QMS and to support the QMS Case Management process.

Standards can not only be used as benchmarks for students or for assessment guidelines, but also the QMS can provide information as to the effectiveness of a standard to be “measured,” and to the extend it really tracks to the skills, knowledge, and abilities intended to be tracked through the benchmarks and the intent (or learning objectives) of the standard.

QMS 16 can be used to guide the development of new standards, and the alignment of standards through the codes, or the development of new codes that facilitate new standards through progressive, inter-connected and aligned ‘chains of reasoning’ supported by aligning the UbD-UDL-ECD-SCCT models.

Information gained through psychometric instruments, such as surveys and questionnaires can be used and compared to student data complied to track, and evaluate a student's self-efficacy, and the processes that ‘work’ are optimal to support, and provide the tools to increase efficacy relevant environmental resources to overcome obstacles.

PSLEDs can be aligned to academic and workforce training with classifications or codes associated with the PSLEDs tailored to each use. For example, QMS 16 can classify and code PSLEDs for a course (e.g., curriculum, instructional, and assessment) to a given ‘theme,’ such as Energy. Learning themes surrounding Energy can benefit from the application of QMS from the following perspectives:
The preparation of students to gain the fundamental ‘energy literacy’ skills and competencies to confidently succeed in an energy workplace being rapidly transformed by occupational and technology demands.
The implementation of energy (and sustainability) related classified and coded PSLEDs through multiple instructional options—flipped classrooms, blended learning environments, homeschool, traditional and online deliveries.
Classified and coded PSLEDs that are configured to cover a range of academic and occupational training opportunities for students, e.g., PSLEDs for convection, conduction and radiation aligned to mathematics and science courses and similar PSLEDs aligned to a Career Cluster for Energy.
Tailor specific classified and coded PSLEDs utilizing UDL for ranges of learning communities, e.g., a rural community college utilizing an agricultural representation of the convection, conduction, and radiation PSLED, where a selected PSLED is based on the PSLED's classification and the targeted representation for the environment, in this case a rural community college.
Facilitate student mobility and credit transfer decisions through the use of equivalency maps based on classifications of a PSLED or series of PSLEDs.

QMS 16 can classify each PSLED element (e.g. video, instructional guide, experiential activity, insertion into an online text, ‘text cert’) based on appropriate academic standards and workforce training guidelines, e.g., CCSMP, NGSS, and Energy Career Clusters.

The embodiments discussed above include descriptions related to classification and codification of PSLEDs, clusters of PSLEDs, and courses related to workforce training, academic settings, and other learning environments. These also include the use of the QMS 16 to create the real-based processes, protocols and procedures to ‘case manage’ the student through and across learning experiences, learning domains, learning trajectories, career aspirations, and workforce mobility. The system can also be expanded to including classification and codification of any learning environment, including for example work experiences. For example, every time a surgeon performs an appendectomy, the surgeon can earn a code for the procedure (that can be based on the underlying skills utilized) and a code representing the proficiency with which the appendix was removed. Procedure codes can include variations that account for initial diagnosis competency, verification on removal, and recovery times and environmental or physical circumstances. Proficiency codes can include grading information for each surgical performance. Doctors can be evaluated based on experience and proficiency. Doctors with lower numbers of experience and proficiency codes can take additional training as one means of earning additional codes. Doctors can use the codes earned to advertise their experience and proficiency and justify pricing based on experience. Prospective patients can use codes to search for and find doctors.

A similar classification system can be implemented for virtually any area of skilled employment and keep with the considerations described herein. For example, codes can be used to screen students and workers for occupational competencies when evaluated to find the most appropriate career pathway or hire-ability. Moreover, the experiential codes can work hand-in-hand with the course codes described above. For example, a job can offer training in addition to the experience metrics. Codes related to job training, experience, and academic courses can all be tracked and used by a user to demonstrate expertise. Codes related to specifics of a practitioner can also serve to align Rubrics in jobs of similar function. Codes can be used to identify KSAs required to fulfill adaptability and trainability for a student or worker.

Further, although much of the above disclosure is described around the implementation of PSLEDs as a learning basis, one skilled in the art will understand that current academic courses and training programs can be classified and coded using techniques and principles within the disclosure of the techniques described herein. Such coding can also account for individualities such as developed through the SCCT model, psychometric testing, physical restraints, and the like. Also, a case management system can be implemented based on current academic courses, training programs, and work experience that tracks individual completion of the classified courses and awards and tracks codes based on their completion.

QMS 16 can also create a “genetic” code based on the accumulated codes of individuals in the QMS. The “genetic” code can be the totality of all codes earned by an individual along with other coding information such as when the code was earned or the type of code earned. For example, coding information can include whether the code is an academic formal, academic informal, academic experience, work formal, work informal, or work experience code. An academic formal code can be a code earned in a course setting in a learning institution. An academic informal code can be a code earned informally through connection to a learning institution, such as through tutoring, mentoring, or teacher conferences. An academic experience code can be a code earned through experience associated with an academic institution. The worker-type codes can parallel the academic-type codes. Other types of codes can also be used.

The genetic code can provide a detailed map of an individual through the individual's total experience and performance associated with the experience. Based on the codes, educational and workforce training can be built up, customized, or suggested. Based on each newly gained code, the recommendations can reconfigure. Different, standardized variations can be aligned, assessed, and research developed to determine how the code variations impact individuals/cohorts education and advancement. Codes can be used to track a person, and to develop specific diagnostic tests and interventions like we do in healthcare with genetic codes. Codes can also be used to analyze demographics to determine what personal attributes different people have in common that come from different points or originate at a same start point. For example, individuals can be compared that all have Elementary education at a particular school or from a particular over years of data. Employers and universities can use this data to attract individuals by demonstrating above average academic and career success for attending such establishment.

Such a string of codes can be long. As such, filtering mechanisms can filter to include or exclude certain types of codes, certain date ranges associated with codes, and certain proficiencies associated with codes. Filtering can create a subset of codes that may describe a certain aspect of the individual. For example, codes can be filtered based on whether their type is academic formal, academic informal, academic experience, work formal, work informal, or work experience code. Or, codes can be filtered based on whether the individual received a strong evaluation for the code earned. Custom interventions can be developed to target individuals with commonalties and differences based on the “genetic” code, thereby expending resources to maximize return on investment.

As disclosed, embodiments implement a quality management system (“QMS”) for creating and managing PSLEDs. Creation of PSLEDs include analyzing and aligning course goals to 21st century KSAs. Managing PSLEDs include organizing PSLEDs into clusters of PSLEDs or courses, and awarding credentials or micro-credentials and certifications based on the completion of PSLEDs. Embodiments implement a database of PSLED for QMS, institutional, personal, or mentor tracking. Embodiments also provide an interface to PSLED content through course instruction techniques that can include lectures and problem solving. Managing PSLEDs also includes benchmarking, comparing, and assessing PSLEDs to evaluate their impact on their stated goals.

One of skill in the art will understand that, as used herein, teacher or instructor denote any person that present's PSLED content to a person learning the PSLED. Similarly, as used herein, student or practitioner denote a user of a PSLED for learning. In some embodiments, teachers can also be students, and also case managers. As used in this description, unless otherwise noted ‘or’ should be understood to be used inclusively. Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A system for managing learner education, career planning, and workforce mobility, comprising:
a database configured to store:
a plurality of course codes with each of the plurality of course codes corresponding to a classification of a course, the course comprising a learning unit or combination of learning units;
a plurality of learner information including at least one course code corresponding to the classified course and one assessment code corresponding to assessment information for the classified course; and
an interface configured to suggest recommended courses for one or more learners, the recommended courses being based on the learner information.

2. The system of claim 1, wherein the learning unit corresponds to at least one of: a formal education environment, an informal education environment, a professional continuing education environment, a workforce training environment, or equivalent workforce experience.

3. The system of claim 2, wherein the learner information includes at least one of: prior codes earned for prior courses, teacher feedback, supervisor feedback, mentor input, personality evaluations, or psychometric evaluations.

4. The system of claim 3, further comprising:
a profile analyzer module for analyzing a learner profile including the learner information; and
a course analyzer module for analyzing available courses; and
a course recommendation module for recommending courses based on the learner profile and available courses.

5. The system of claim 1, wherein the course comprises one or more Problem Solving Learning Environments and Design (PSLED) blocks.

6. The system of claim 1, wherein the learner information comprises worker information, and the system further comprises:
a worker tracker interface for human resources for:
providing guidelines for worker advancement; and
providing an individualized advancement plan for a worker, recommending experience and training required to achieve worker advancement,
wherein the individualized advancement plan is based on the guidelines and the worker information, and
wherein the worker information includes information about prior learning units earned academically and information about prior learning units earned in the workforce.

7. The system of claim 1, wherein the database classifies, stores, and tags multiple codes related to learning units, and wherein the codes are used to develop rules and structures, weights and models, and algorithms to create codes and code classification schema and hierarchies.

8. The system of claim 1, wherein the database classifies, stores, and tags multiple codes related to learning units, and wherein the codes are used to develop student centric education and career plans, workforce training plans, human resource guidelines for hiring and advancement, PSLEDs, Rubrics, lesson plans, units of study, courses, course of study, degrees, internships and apprenticeships, informal activities, cost and re-imbursement models, revenue models, or educational and workforce policies, customized reports, predictive analytic algorithms, common data definitions

9. The system of claim 1, wherein the database classifies, stores, and tags multiple codes related to learning units, and wherein the codes are used to develop an open source education and workforce training system.

10. The system of claim 1, wherein the database classifies, stores, and tags multiple codes related to learning units, and wherein the codes are used to create, support, and develop new algorithms for: online courses, case management, tutoring, personal learning assistants, lesson plans, degrees, apprenticeships, workforce training and professional development, or hiring and advancement within the workforce.

11. The system of claim 1, further comprising:
a search module for searching the codes; and
a weight module for weighted codes for modeling, classifying, and ranking student achievements.

12. A system of crediting a course, comprising:
a database storing information for a course including a plurality of code segments, each code segment representing a learning segment of the course, the course comprising one or more learning units;
a course crediting module for receiving code segment information from a learner corresponding to a missing code segment for the course; and
a course awarding module for analyzing completed code segments and awarding a completion code to the learner when a criteria for code segments required by the course is complete.

13. The system of claim 12, wherein:
the code segment information received by the course crediting module is received from an external source.

14. The system of claim 12, wherein:
the code segment information received by the course crediting module is associated with the completion of a second course, wherein code segment information is in criteria for both the course and the second course, and wherein the course awarding module awards a second completion code to the learner for the course based on the code segment information in the second course.

15. A system of managing a learner's learning, comprising:
a case management module for tracking a learner's personal attributes, learning, and career progress;
a prediction module for analyzing the learner's progress, personal attributes, and assessment information for predicting the performance of the learner in an available course; and
a course recommendation module for analyzing the learner's progress and recommending courses based on the learner's progress, the learner's personal attributes, and the predicted performance.

16. The system of claim 15, wherein the course recommendation module recommends courses based on the learner's career progress and achievement of career goals.

17. The system of claim 15, further comprising:
an intervention module, based on the learner's progress, personal attributes, and assessment information, for intervening on selected courses of the learner's based on the learner's individualized academic and career plans.

18. The system of claim 15, wherein the prediction module analyzes codes associated with progress of the learner and codes associated with the available courses.

19. The system of claim 18, wherein the prediction module determines, as part of the performance prediction, whether the learner is likely to have success in learning environments offered by the available courses.

20. The system of claim 18, wherein the prediction module determines, as part of the performance prediction, whether the learner is likely to have success in career advancement offered by the available courses.

21. A system of classifying a course, comprising:
a course classification module for classifying a course based on learning environment and subject criteria;
a course segment classification module for classifying segments of a course based on targeted skills and assessment criteria;
a coding module for assigning a code for each course segment and assigning a code for the course; and
a coding assessment module for assigning codes corresponding to assessment criteria for each course segment and assigning codes corresponding to assessment criteria for the course.

22. The system of claim 21, wherein the learning environment includes at least one a traditional learning environment, a flipped learning environment, an online environment delivered on a tablet, smart phone, or computer, and tutoring learning environment.

23. The system of claim 22, wherein the course segment classification module further classifies course segments based on a target audience, wherein the target audience includes: students, teachers, instructors, professionals, practitioners, mentors, or peers.

24. A system of rating an individual, comprising:
a code analyzing module for analyzing codes earned by the individual; and
a rating module for rating the individual based on the codes earned.

25. The system of claim 24, wherein the codes include codes associated with professional experience.

26. A method of applying code profiles to individuals comprising:
evaluating an individual based on the individual's performance in an activity;
applying an activity code to the individual, the code representing completion of the activity; and
applying a proficiency code to the individual, the code representing a proficiency level associated with the activity, the activity and proficiency codes combining with other achieved codes to provide a coded description of individual activities.

27. The method of claim 26, further comprising:
filtering to extract codes associated with an individual based on code type, where the code type is consistent with at least one of academic formal, academic informal, academic experience, work formal, work informal, or work experience.
